(19) United States
(12) Patent Application Publication
(10) Pub. No.: US 2015/0127405 A1
(43) Pub. Date: May 7, 2015

(54) STATE-OF MIND, SITUATIONAL AWARENESS ENGINE APPARATUS AND METHOD

(71) Applicant: SpinGo Solutions, Inc., Draper, UT (US)

(72) Inventors: Kreg Peeler, Provo, UT (US); Kenneth Foisy, St. George, UT (US); Clayton Ferris, Tucson, AZ (US)

(21) Appl. No.: 14/477,716

(22) Filed: Sep. 4, 2014

Related U.S. Application Data
(63) Continuation of application No. 14/072,458, filed on Nov. 5, 2013, now abandoned.

(51) Int. Cl. G06Q 10/10

(52) U.S. Cl. CPC G06Q 10/1095
USPC 705/7.19

(57) ABSTRACT

A networked system of computers, connected dynamically, often very temporarily (e.g. phone call, text, web search), based on individual criteria unique to and controlling each, as they temporarily opt in to the system to evaluate information. All may process data obtained from a database mashed together by combining highly persistent (years) with highly transitory (minutes to weeks) data, temporarily bound thereto. Distributed processing by individual, independent processors is controlled by their own individual criteria, facilitating population, storing, indexing, searching, navigation, querying, and serving of heretofore unwieldy content. Applications execute heretofore impossible procedures as dynamic as situational awareness and personal decisions by their operators. In one example, transitory events can be incorporated by combining persistent data records with temporary ones on a customized site serving an event calendar from a media site, and commercial entities can tap into predictions based thereon.

### BACKGROUND

1. Related Applications

This application is a continuation of and claims priority to U.S. patent application Ser. No. 14/072,458 filed Nov. 5, 2013 which claims the benefit of U.S. Provisional Patent Application Ser. No. 61/790,113, filed Mar. 15, 2013, which is hereby incorporated by reference. Additionally, this patent application hereby incorporates by reference U.S. patent application Ser. No. 10/791,134, filed Mar. 2, 2004.

2. Field of the Invention

This invention relates to computer networks and, more particularly, to novel systems and methods for dynamically interconnecting multiple, distinct, independent computers based on processing instantly consolidated, persistent and transient data.

3. Background Art

Situational awareness modeling has been developing over decades in the fields of military operations and emergency responder operations. Nevertheless, situational awareness has not been available in real time for commercial operations, such as retail stores, brick-and-mortar manufacturers, sellers, and the like. Meanwhile, event calendars have suffered greatly because event data is highly transitory. Databases may be set up with schema and data that is substantially persistent. However, events come from numerous, disparate, non-standardized formats and sources. Their funding and expertise available for getting their information distributed are widely disparate between events and entites.

For example, a youth club, a school, a rock band, a symphony orchestra, a commercial enterprise, a social organization, or any other type of ad hoc group or cause may schedule an event. Publicizing that event, getting it available to the public, advertising it, making the information regarding it available to the public, and so forth is not a standardized process. Moreover, with every event comes unique information, and a lack of standardized formatting for the information to be provided.

The word that comes up most often with respect to events is “unwieldy.” Unwieldy characterizes the almost random nature of promoters, participants, contributors, organizations, and so forth that may launch an event. Moreover, unwieldy characterizes the excessive cost and the minimal benefit of the news value of any individual event.

Event calendars are typically unreliable. They have difficulty obtaining timely and accurate information, formatting it all consistently, and deleting past events. Web crawlers have been developed to crawl websites and collect data, but suffer from tremendous unreliability, false entries, out-of-date entries, and other inaccuracies.

To date, the cost-benefit relationship for an event database has simply not been justified. Newspapers, other media sources, and the like often provide event information as a public service. Likewise, they may accept advertising for events as commercial endeavors. However, the plethora of events within a community, city, geographical region, or the like is not well served at present by any media outlets. The fact that the information is so totally unwieldy makes the collection of that information and its dissemination an expensive proposition having no payoff as a news item. Accordingly, there exists no suitable mechanism in the prior art for providing reliable, timely, comprehensive, accurate, cost-effective event data to the public or other users.

What is needed is a system of hardware and software implementing methods for locating, harvesting, verifying, updating, disseminating, analyzing, predicting, processing, and otherwise making available data to and from consumers, commercial enterprises, and others, a reliable, dynamic, combined, hybrid-of-persistent-and-transitory-data database of event information.

### BRIEF SUMMARY OF THE INVENTION

In view of the foregoing, in accordance with the invention as embodied and broadly described herein, a system, apparatus, and method are disclosed in various embodiments in accordance with the present invention as including computer hardware, programming software, interconnecting between devices over the internet to create, store, maintain, update, and query a dynamic database for distinct, different, but complementary purposes of all computers and their controlling entities connecting to and relying on the system.

A system and method in accordance with the invention provide an advance in the art by providing an efficient, combined database, rapidly responsive to updates and queries, by combining temporarily persistent data records and transitory data records, thus optimizing dynamic adaptability, while not burdening the support system with upkeep of transitory data throughout.

A system and method in accordance with the invention provide a dynamic combination in a database serving up data directed to a public service of advertising very local events, hosted along with other commercially driven news, available to users accessing conventional media outlets on the web and elsewhere.

A system and method are disclosed providing a computer system serving data to commercial entities that gives a situational awareness to commercial conditions that are extremely transitory, even lasting for less than an hour or a few hours. A situational awareness engine is available to commercial entities through participation of hosts of events and attendees, as well as other entities involved in putting on, promoting, or otherwise involved in any way in the event.

A system and method are disclosed providing hardware and software programmed to provide indirect, dynamic capture of demographic data at a very detailed level over social media platforms participating over the web, even driven by such platforms available to connect over the web before, during, and after an event.

A system and method are disclosed providing hardware, software, and methods implementing an expert system embedded in a database builder directed to events, but storing persistent data that will remain extant for years and repeatedly appear over many events otherwise unrelated, along with transitory data corresponding to an event that may or may not ever repeat, and may only exist for a comparatively brief time of hours, days, or weeks.

A system and method are disclosed that provide hardware and software programmed to create and maintain dynamic, temporary records of demographic information and demographic predictions that reflect conditions that may only last for minutes, hours or days, a fete heretofore unheard of in databases of events, in calendars, or the like.

A system and method are disclosed to provide hardware and software programmed to create, store, query, and serve records constituting an event database. A dynamic calendar generator contains and selects instantly, pre-classified information and serves it to a dynamic, customized calendar created by a computer system based entirely on criteria selectable and selected by a media outlet entity, and hosted on a website directed to the services and information of that entity.

A dynamic, temporary-demographics predictor system comprises hardware and software programmed to use database information associated with events to infer characterization of groups of attendees at events, their travel paths, and their likely state of mind, thus engaging commercial computer systems of purveyors of goods and services located in the traffic patterns to provide engagement with attendees through digital devices or conventional information displays directed to that targeted, unique, temporary demographic and inferred state of mind.

A hybrid database by contain records of inherited data from persistent entities, in which characterization and other data is largely persistent over times such as months, years, or even decades. Meanwhile, accessible and processed with the persistent data is highly transitory data, even singular properties, characteristics, or other data temporarily bound during its brief existence (of minutes, hours, days, or weeks, typically) to the persistent data. This provides dynamic and updated information without the unwieldy schema and overhead of conventional databasing.

A system of hardware and software implementing methods in accordance with the invention may provid to promoters associated with the promoting or putting-on of an event a mechanism for making their event more publically available. Moreover, a system and method in accordance with the invention may provide to the consumer public access to a database of pertinent information about events that is much more robust, complete, dynamic (more timely responsive, updated, targeted, and accurate), and reliable than any conventional system.

Meanwhile, partner organizations may include media groups or other organizations that maintain websites for the purposes of their group or enterprise. These websites may import a calendar updated by a consolidated database. The consolidated database may include persistent data harvested from organizations and websites that have a persistent dwell time. For example, businesses, schools, entertainment venues, sport facilities, and in general, any facility associated with a permanent organization building, will typically have a persistent address, management, contacts, and the like.

An event may be an ad hoc creation of a group which may or may not be persistent. The event itself may be a once-in-forever event, a regularly scheduled event, or anything in between. Accordingly, in a system and method in accordance with the invention, a system and method provide for harvesting of transitory data associated with events, harvesting of persistent data associated with buildings, facilities, infrastructure, organizations, and the like, and the consolidation of these two types of information into a single database that is dynamic, and readily available. In certain embodiments, the data regarding events may be presented in association with a calendar, or in a calendar format. Such calendars may be hosted by various licensees who receive filtered event data from a central event database tailored to the desires and tastes of the hosting organization.

The event engine for creating the event database may accommodate receipt of event information from the public, sponsors of events, promoters or presenters of an event, any attendee or party with any interest in an event, news organizations, or the like. Thus, in a system and apparatus in accordance with the invention, a very low cost system and method provide highly reliable data regarding transitory events. Event database records may be augmented or built to include certain inherited data corresponding to any persistent person, place, or thing that may be linked to the event. Accordingly, reliability is improved, predictor-corrector techniques may be used for harvesting and verifying data, and consumers and commercial enterprises alike may gain access to such data.

In certain embodiments, commercial enterprises may rely on use situational awareness engines to generate data supporting targeted advertising at times, places, and to demographic profiles very specific to an event, venue, and attendees. Thus, brick-and-mortar sites of commercial retailers can finally obtain a situational awareness of their own locally significant events, and reap the benefits of a mobile and socially connected network of persons attending an event. Social media may provide a connection between mobile platforms owned by various individuals who have a relationship unrelated to an event or related to the event. Meanwhile, this shared demographic that exists temporarily for an event may be fed to a commercial retailer in order to be used in highly directed advertising in the locale and related any aspect of the attendees or the event held at a local venue.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a system of computers in a network and internetwork suitable for hosting software and implementing a system and method in accordance with the invention;

FIG. 2 is a schematic block diagram of one embodiment of a system of hardware in accordance with the invention;

FIG. 3 is a schematic block diagram of executable modules operating in accordance with the invention;

FIG. 4 is a schematic block diagram of an event engine operating within the system of FIGS. 1-3;

FIG. 5 is schematic block diagram of additional selected details of the system of FIGS. 1-4;

FIG. 6 is a schematic block diagram of a process for extracting, verifying, and analyzing event data in accordance with the invention.;

FIG. 7 is a schematic block diagram of a process for creating and consolidating persistent and transient record data;

FIG. 8 is a schematic block diagram of details of a harvester module in accordance with the invention;

FIG. 9 is a schematic block diagram of a harvester management module;

FIG. 10 is a schematic block diagram of selected tables or records;

FIG. 11 is a schematic block diagram of association tables;

FIG. 12 is a schematic block diagram of problems list and remediation list;

FIG. 13 is a schematic block diagram of surrogate control data;

FIG. 14 is a schematic block diagram of selected details for a surrogate engine;

FIG. 15 is a schematic block diagram of an operational process for a surrogate engine;

FIG. 16 is a schematic block diagram of a situational awareness engine and process;

FIG. 17 is a schematic block diagram of one embodiment of a capture and intervention process;

FIG. 18 is one embodiment of a harvesting and delivery process;

FIG. 19 is a schematic block diagram of a process for creating and controlling an event calendar;

FIG. 20 is a schematic block diagram of a screen image of a host site of an event calendar;

FIG. 21 is a schematic block diagram of an image of a screen shot of an event calendar web page;

FIG. 22 is a schematic block diagram of various optional modules stored in computer memory;

FIG. 23 is a schematic block diagram of one embodiment of a method for implementing situational awareness marketing;

FIG. 24 is a schematic block diagram of selected optional modules for implementing a front-facing tool implementing certain features in accordance with the invention; and

FIG. 25 is a schematic block diagram of selected optional modules for implementing management of a queue of events for inclusion in an event database and event calendars.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

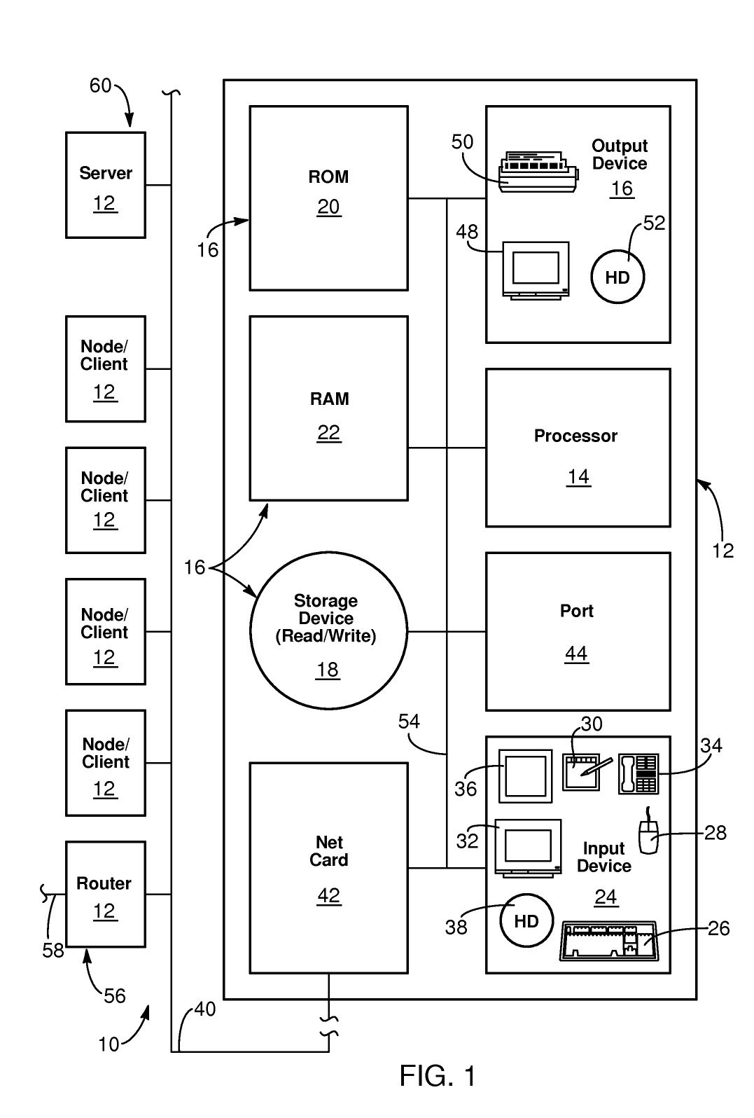

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments.

For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

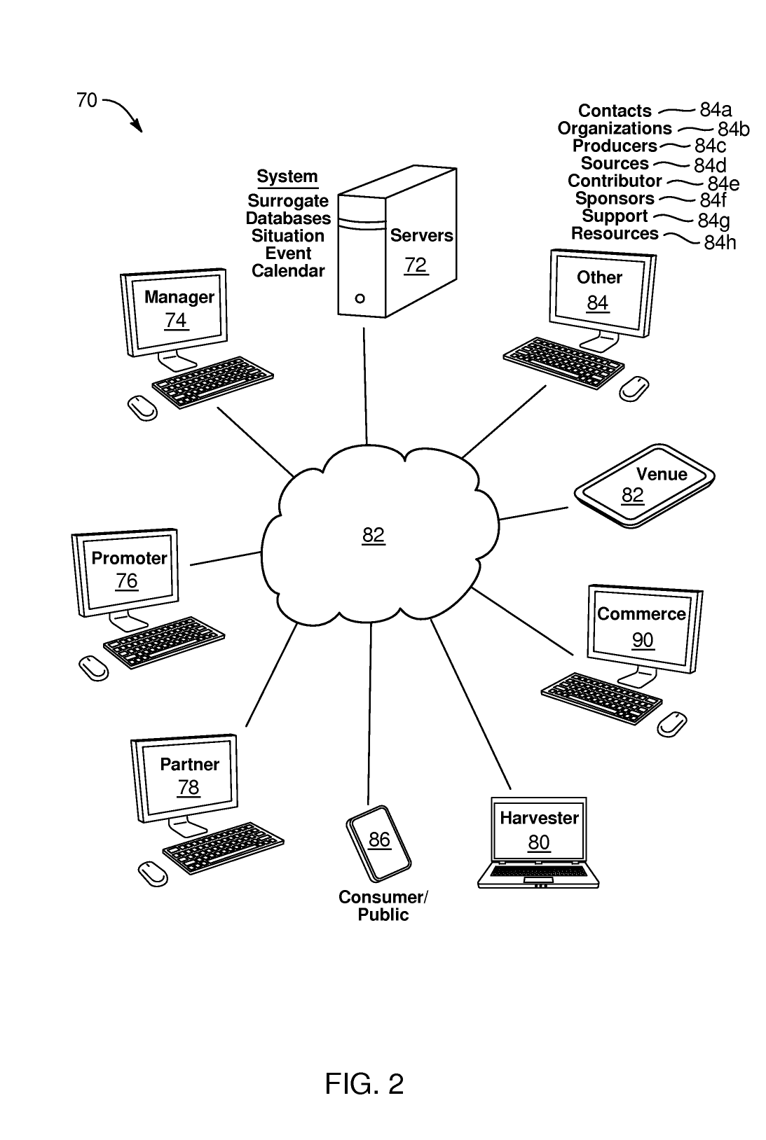

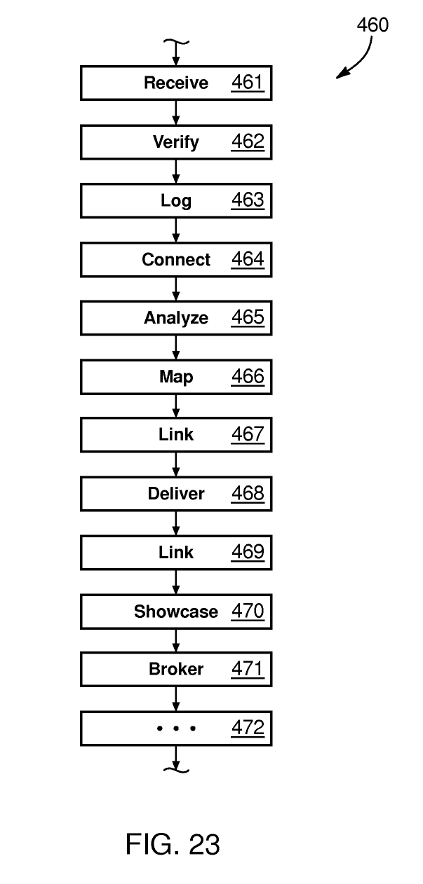

Referring to FIG. 2, and FIGS. 1-25 generally, a system 70 in accordance with the invention may include several components configured as a system 70 or suite 70, each component thereof performing a specific function. For example, in the illustrated embodiment, a system server 72 may host various software and hardware, such as a database, a situation awareness analysis in presentation system, an event database, a surrogate engine 120 for learning from and feeding back to a human intervention agent 101 operating a harvester computer 80. Every computer may have a human operator designated by the same number.

Likewise, a system 70 may include a manager computer 74, or manager 74. The manager 74 may be responsible for the administration of the functions of the servers 72, as well as the training, supervision, management, verification, feedback, and so forth associated with a harvester computer 80, and an individual specialist 101 or intervenor 101 operating the harvester computer 80.

In certain embodiments, a promoter 76 or promoter computer 76 may be owned, controlled, operated, and otherwise used by an entity, whether individual, corporate, organizational, commercial, or otherwise, putting together an event. As used herein, a system 72 means the computer system, software, and associated functionality responsible for providing both a dynamic event database, as well as a situational awareness system for use by commercial entities.

A manager 74 signifies the entity, person, computer, and associated functions, personnel, and equipment, including software for managing the system 72, and the harvesters 80. The term harvester will apply to a computer 80, as well as an individual verifier or operator of the harvester computer 80. The meaning should be clear from the context. Likewise, by promoter 76 is meant the entity, individual, computer system, and software modules affiliated with an event, and specific to the event. A promoter may be thought of as the persons, organizations, and systems that are “putting on” an event. Thus, these will promote an event for their own reasons. The system 72 may have relationships with partners 78 or partner computers 78. A partner is an individual, organization, entity, business, computers, software, and the like that uses the event database 150 provided by the servers 72, as an adjunct to its own purposes, or their own purposes. In general, the partner computer 78 may be the enterprise computer of an organization such as a news organization or other media outlet or group. Thus, a partner computer 78 may sponsor a local calendar 272, an event calendar, or the like relying on the servers 72 for the updated, reliable event data and even the entire calendar 272 of events. In some embodiments, the partner computer 78 may simply provide a window or frame in which an event calendar is served up by the server 72.

In certain embodiments, a harvester 80 or harvester computer 80 may be operably connected to a system 72 or system server 72 in order to provide information into a database 150. Typically, by harvester 80 is meant a computer 80, an individual, software, or any combination thereof of the three alone operating to provide transitory information related to an event to the database servers 72.

A venue computer 82 or a venue 82 means a computer 82, individual, organization, building, or any combination representing a location where an event may occur. Again, with respect to FIG. 2, all definitions may be used to represent individuals or organizations, physical locations, computer hardware, computer software, or any combination thereof, and will be clear from the context. Typically, a central element of a venue 82 is a facility, such as an arena, stadium, building, hall, or other facility suitable for holding the attendees and the necessary technical hardware required by an event. Venues 82 typically have the most persistent locations of any entity of FIG. 2. Businesses may change their leases, but a stadium, sports arena, or the like is a physical facility that is expensive to create, and not readily dismantled or taken out of service. Thus, data corresponding to a venue 82 will typically be highly persistent. Transitory data is typically correct or pertinent less than days, weeks, or maybe months. Persistent data is typically so for years.

Other computers 84 (specific instances being 84a through 84h) may include, for example contributors 84e who will have some function related to an event. For example, performers are contributors 84e. However, other people are also contributors 84e. Likewise, infrastructure, equipment, and the like may be provided by various contributors 84e. Meanwhile, other entities 84 may be producers 84c who provide management, financing, advertising, or the like or who provide the equipment, personnel, skills, and the like in order to produce an event 97. Likewise, sources 84d may be included, such as individuals who have information or other assets related to an event 97. Meanwhile, sponsors 84f may be temporarily or permanently associated or affiliated with an event 87. Typically, sponsors 84f are comparatively persistent organizations such as radio stations, purveyors of products, such as beverages, memorabilia, and the like, who may benefit from sponsoring an event 97, and so forth. Meanwhile, other support entities 84g, individuals, and the like may be affiliated with various computers 84, as well as may other resources 84h. Thus, in general, the various computers 84, software affiliated or executing thereon, and the individuals or entities affiliated therewith may and be referred to by the same names, and may be understood by the context of use. The public user 86 or computer 86, illustrated as a hand held device 86, such as a smartphone 86, Personal Digital Assistant (PDA) 86, or the like may be thought of in general as a party potentially interested in, or attending an event. Typically, one may think of the public 86 as the consuming public 86. Nevertheless, individual members 86 of the public 86 have individual public devices 86, such as computers, smartphones, tablets, and the like, all of which may be thought of as public devices 86 or users 86.

Typically, all entities, through their hardware 74, 76, 78, 80, 82, 84, 86, 90, or as their individual entities or persons, or as their software applications executing on said devices 74-90, may connect over an internet 88. Accordingly, each may access the other under the proper circumstances, with software, such as browsers, hosted applications, and so forth.

A commerce computer 90 or a commercial entity 90 in position of control of a commerce computer 90 may be thought of as a user of situational awareness information provided by a server 72. For example, by a commerce computer 90 or a commercial entity 90 is meant the hardware, software, entity, person, or any combination thereof affiliated with a commercial enterprise. Typically, a commerce computer 90 is affiliated with and resides at a brick-and-mortar commercial institution 90. For example, common retailers, whether small “mom-and-pop” shops or big-box discount retailers such as a Wal-Mart, Target, or like, these entities typically are in fixed facilities. They have a need for a situational awareness of the potential markets flowing about them and passing by them on their way to and from a particular venue 82 at which an event is held. A public device 86 is associated with an individual 86 or group 86 who is most interested in finding out about events. The harvester 80 is tasked with harvesting event information to feed into a database 150 supported by the server 72. A promoter 76 is responsible to “put on” an event. A partner 78 providing as a public service or for any other purpose a calendar 272 of events 97, typically used as a draw for other services. For example, news and entertainment media need and desire to have up-to-date, accurate, comprehensive data regarding events, they can hardly afford the unwieldy task and potentially catastrophic expense of providing such, from which they derive very little commercial benefit. However, in a system and method in accordance with the invention, such partners 78 host calendars 109 of events 97 and serve them to the public devices 86. Meanwhile, promoters 76 and harvesters 80 may fill the database 150 with information. This application incorporates by reference U.S. patent application Ser. No. 10/791,134, filed Mar. 2, 2004 in its entirety.

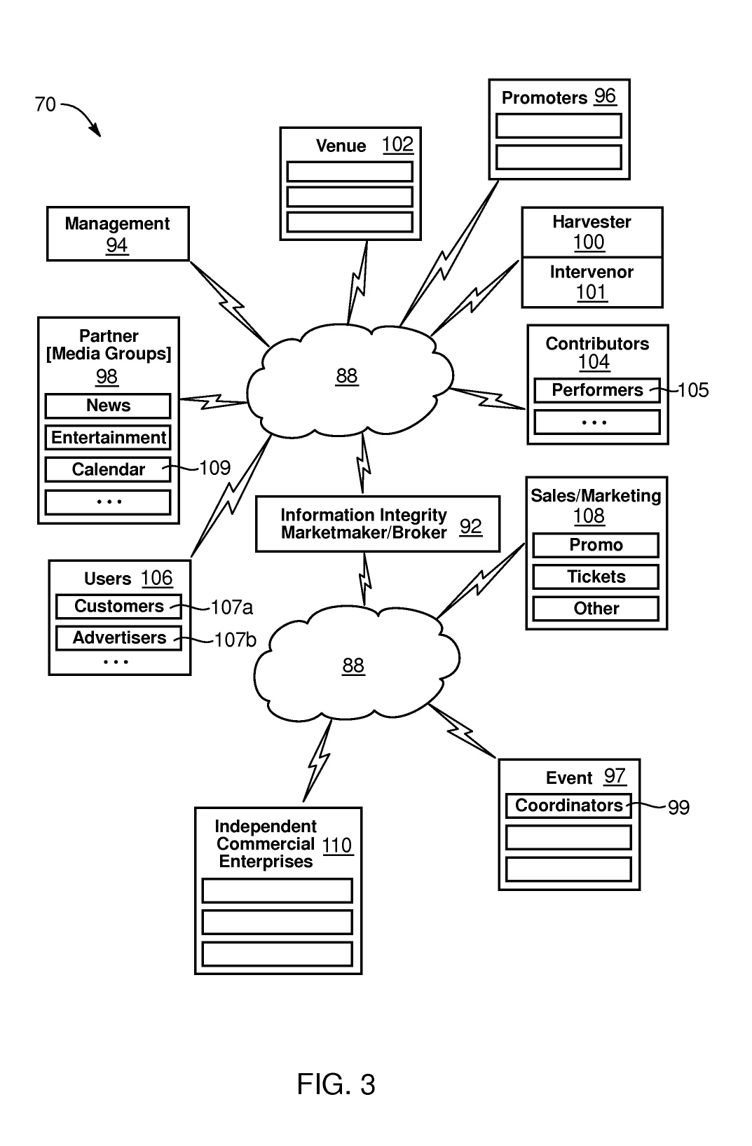

Referring to FIG. 3, and continuing to refer generally to FIG. 1-25, a portion of a system 70 in accordance with the invention may include a broker 92 or market maker 92 that provides information, and assurance of integrity of that information, for events. For example, in the illustrated embodiment, the management 94 and harvester 100 are illustrated as software modules corresponding to the manager computer 74 and harvester computer 80. Meanwhile, a promoter module 96 corresponds to a promoter computer 76 and any entity associated therewith. Meanwhile, event coordinators 99 of an event 97 and, promoters 96 are responsible for an event 97. Nevertheless, there may be other coordinators 99 responsible to put together an event 97, and an executable module 97 for that function.

A partner module 98 may be affiliated, for example, with a media group or various media groups. These may include news, entertainment, other media services, and the like. Typically, such a software module 98 is associated with and executing on a partner computer 78. A harvester module 100 executes on a harvester computer 80, while a venue module 102 executes on a venue computer 82 affiliated with a venue as described hereinabove. Typically, various contributors 104 may be affiliated with one of the other computers 84e. Contributors 104 may include, for example, performers 105. Likewise, agents thereof, producers 84c, and others who have created an act or who manage the talent or performers 105 for an act may be considered contributors 104, and may operate from a contributor module 104 on a computer 84e connected to the internet 88 to communicate with the network of systems and entities represented therein.

Typically, a user module 106 may be hosted on a public computer 86 of an individual customer, 107a or advertiser 107b, such as may be hosted on a user 86 or on a commerce computer 90. Typically, the user modules 106 are adapted as applications 106 suitable for running on a computer 86, PDA 86, or other device 90 according to the person or organization with which its affiliated. For example, individual retail customers 107a or attendees of events will typically use a PDA 86 or tablet 86 while mobile, or perhaps a desktop computer 86 in a home or office to host an application 106 directed to their use. In other embodiments, the user module 106 may simply be a browser accessing the data provided by the market marker 92 or broker 92. More likely, the user module 106 for a retail or consumer customer 107a may simply be a browser 106 accessing a calendar 272 on a partner computer 78 hosting partner software 98 displaying a calendar 272 created by a calendar module 109.

For example, a calendar module 109 may create, or may simply display the calendar information provided by the market maker 92 or broker 92 that is serving up from the servers 72 and event database 150. Meanwhile, the promoters 96 may actually be creators of the event 97. For example, an event module 97 may be the software necessary for a promoter 76 to provide information, and is typically in or affiliated with the site or website 97 for an event. Typically, the event website 97 is hosted on a computer 10 of a promoter 76, but may be independent or free standing. In some embodiments, an event module 97 may be thought of as the original source to which a harvester module 100 will refer a user module 106 interested in additional information beyond that available on the calendar 272.

Sales and marketing modules 108 may be affiliated with sales and marketing entities who may have various interests that become associated with an event 97 represented by the event module 97. For example, beverage makers may provide promotions, radio stations may provide free tickets, and others may be involved in ticket sales, ticket giveaways as promotions for themselves, or the like. Typically, ticket sales and other marketing efforts may be hosted or run by software modules 108 directed to sales and marketing different from those of the actual promoters 96 of an event 97, and those interests of the partners 98 who sponsor event calendars. Ticket sellers and resellers, radio stations, food and drink purveyors, memorabilia outlets, and the like may run modules 108 related to their services and affiliated in some way with an event 97. Typically, the sales or marketing modules 108 are not on the site 97 of the event itself. Nevertheless, in some embodiments, such entities may become sponsors 84f, and thus place their logos on the webpage of the event module 97, and promote the event 97 in some type of commercial relationship with the promoters 96, that will benefit the sales or marketing system 108 with product exposure at the event or in its advertising and promotion.

The commercial module 110 is typically that of an independent commercial enterprise 90 represented on a website 110. For example, a commerce computer 90 sponsors a commercial module 110 that serves its purposes. Typically, the independent commercial module 110 or simply commercial module 110 is a representation in the commerce computer 90 of the entity that benefits from the situational awareness provided by the market maker 92 or broker 92. That is, the market maker 92 or broker 92 may be thought of as making the market or assisting to make the market for an event, at reasonable cost. That is, the market maker 92 may provide a base level of information at no cost, much as the telephone directory or the advertising directory would simply list all businesses. The market maker 92 may list all events possible.

Nevertheless, operating as a broker 92, the broker 92 may sell upgrades to promoters 96 to highlight or feature herewithin enhanced format, such as pictures, video, moving banners, enlarged space, highlighting, location, and the like in order to provide additional exposure for an event 97. Meanwhile, the broker 92 may also provide to the independent commercial enterprise 90 affiliated with the commercial module 110 and commerce computer 90 the situational awareness data permitting the commercial module 110 to place advertising at 3 or directed to bring traffic into, brick-and-mortar locations near a venue 82, 102 affiliated with an event 97. In this way, the independent commercial enterprise 90 hosting the commercial module 110 may have very precisely directed advertising to a demographic and mind set affiliated with attendees at the event 97. The availability of analytics, historical data, demographic information, subject matter, social links, “pull” requests, and other information related to the nature, types, and numbers of attendee users 86, 106, at an event 97, may provide a highly qualified audience in a locale of the commercial establishment 90.

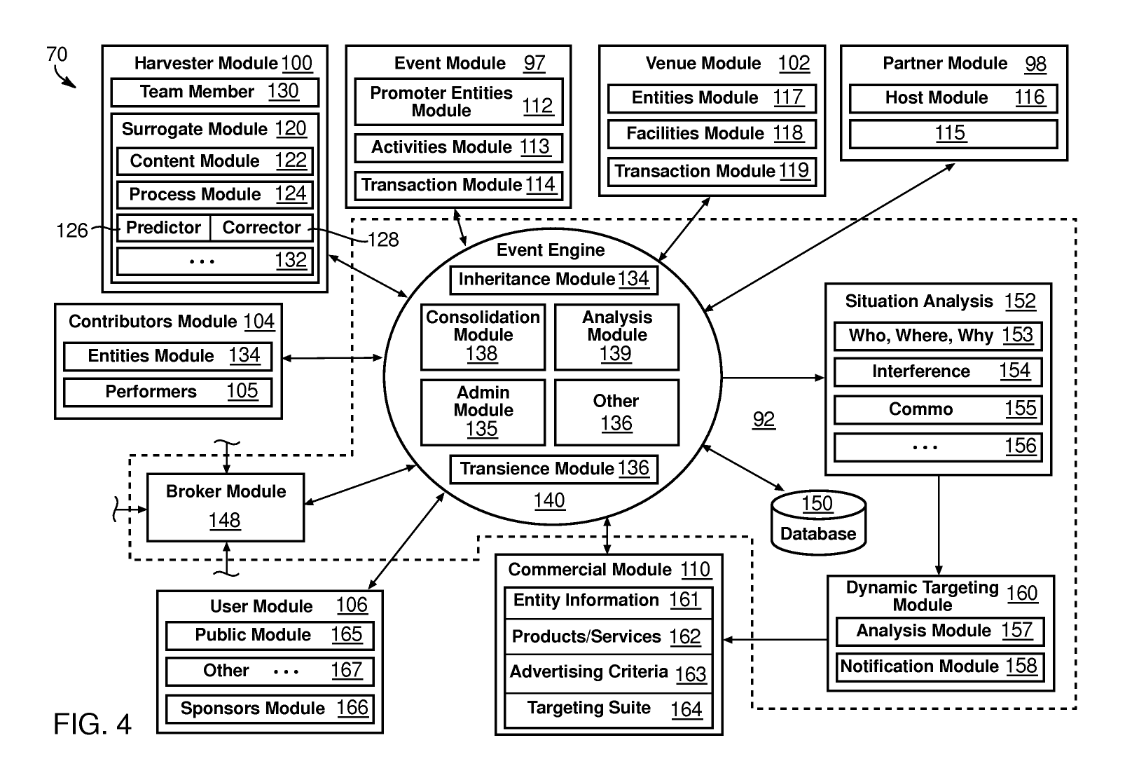

Referring to FIG. 4, and continuing to refer to FIGS. 1-25, in one embodiment of an apparatus and method in accordance with the invention, an architecture for the system may be shown in one particular arrangement with additional details. In the illustrated embodiment, the event 97 may be associated with an event module including entity modules corresponding to promoters. That is, interactions of the promoter computer 76 with the system 70 may be implemented by a promoter module 96 that provides access, editing, communications, transactions, and the like. Any modules may be implemented in an application, on or remote from the server 72, accessed merely by a browser 112 as the entity module 112. An application 112 may be unique in standing alone to provide all of the transactional and informational needs of a promoter 79, 96. The event module 97, interacts with the promoter module 96, or may be the same.

An activities module 113, may be responsible to conduct all of the operational activities required for hosting an activity, at an event 97. Typically, the activities module 113 will be responsible for all transactional activities associated with the activity, which may typically be a game, a show, a band, or some other recreational or entertainment activity. Meanwhile, a transactional module 114 may accommodate the financial interactions and the administrative functionalities between the event module 97, and the broker system 92.

In one embodiment, the partner module 98 may include various other sub modules 115. These may be created according to the desires of the partner showing a calendar 272 including the event 97. However, in general, that is most typical of a partner module 98 is a host module 116 hosting a web calendar 272. The various modules 115 may relate in any of several ways to the business interests of the partner module 98. For example, a news organization will typically have news articles, images, text, links, embedded video, advertising windows, and the like. At least one window available on the website driven by the partner module 98 will access a host module 116 hosting an event calendar 272 from the module 109 served up by the server 72 and originating from the market maker 92, in order to provide a complete, comprehensive, accurate calendar 272 of events 97.

The venue module 102 may include an entities module 117, facilities module 118, transaction module 119, and various other modules. For example, the venue module 102 necessarily must deal with an owner, as well as various organizations that will rent the facility, promoters 96 who will engage the facility, and so forth. Meanwhile, a facilities module 118 may deal with administrative details of the physical facility. The number of rooms, types of rooms, equipment available, power, water, area, the seating capacity, and the like may be managed by the facilities module 118. A transactional module 119 may interact with both the promoters 76 or the promoter module 96 securing the facility. In general, the entities module 117 and facilities module 118 will typically provide information to the event engine 140 as part of the market maker system 92. The event engine 140 is a central software operating on the system servers 72 in creating and maintaining the database 150 of events. Typically, the venue module 102 provides information to the event engine 140 as part of the data that will acquired by the inheritance module 134. The Inheritance module 134 is that portion of the event engine 140 responsible to acquire comparatively persistent data defined above. Typically, it will exist for years. Persistent data may include information related to organizations, physical facilities, performers 105, and the like. In contrast, the transience module 136 is responsible for bringing in and managing the transient data associated with an event 97.

The partner module 98 may include a principal host module 116 as a responsible to host a calendar 272. Indeed it is the calendar module 109 that delivers the additional value at a cost-effective rate for accuracy, comprehensiveness, and local relationship. Other modules 115 exist within the partner module 98 to accomplish other functions. For example, a partner module 98 might typically belong to a media entity or group. Typically, for example, a newspaper that has an online presence may provide news, video, weather, and the like. Such modules 115 may provide the main substance provided to consumers 106 by the partner 98.

Meanwhile, the host module 116 hosts a calendar 272 obtained by the module log from the resources of the market maker 92. The term “market maker” 92 refers to the fact that the market maker/broker 92 provides a market or creates a market for event information by providing broad distribution of events 97. This may be provided at no charge inasmuch as the cataloging or calendaring of events provides a resource of general interest to a broad audience. Accordingly, the host module 116, particularly comprehensive and accurate, provides a draw for the other features of the service modules 115 Likewise, the traffic drawn by the calendar 272 hosted by the host module 116 on the website of a partner 98 provides advertising value and advertising impressions delivered to all those eyes watching the output of the host module 116, namely, the calendar 272.

The venue module 102 may include an entities module 117, facilities module 118, and transaction module 119. These modules 117, 118, and 119 serve the processing needs of the entities responsible for the venue, such as owners, management, and the like. Meanwhile, the facilities module 118 is responsible for the facilities management information and processing of information needed for operating the facilities associated with the venue 102. Similarly, a transaction module 119 manages transactions.

As a practical matter, the venue module 102 is primarily of value to the event engine 140 in that the event engine 140 may draw information about the venue 82 from the venue module 102 in order to identify and fully characterize the venue 82, 102 as an entry in the database 150. For example, a venue 82, 102 does not change quickly nor dramatically. Thus, data for a venue 82, 102 is persistent data. The inheritance module 138 is tasked with retrieving the information from the venue module 102 in order to provide to the consolidation module 138, the persistent data needed for consolidation with the output of the transience module 136.

In certain embodiments, a surrogate 120 may be embodied in the analysis module 139. However, in other embodiments, the surrogate module 120 may actually be embedded in the harvester module 100 or elsewhere. In either location, the surrogate module 120 is responsible for effectively monitoring the actions of the team member module 130 of the harvester 80, 100. For example, the content module 122 is responsible for tracking and training content. It accumulates and handles content delivered to the event engine 140 by the harvester module 100.

Similarly, the process module 124 is responsible for tracking and training on processes. For example, the content module 122 may detect content, its format, and other information surrounding it. The surrogate module 120 may aid the team member module 130 by making suggestions, by providing navigational aids, by automatically going to locations at websites, and the like according to the content 122 and the learning that the surrogate module 120 has made concerning where the content is and what it looks like.

Similarly, the surrogate module 120 may also observe the process by which a team member module 130 is directed by a specialist 101, operator 101, intervenor 101 in searching and extracting information from a website. The process module 124 may be responsible for tracking the actions of the team module 130, which reflect the decisions of a human user 101 as an intervenor 101 responsible to intervene and verify the information harvested by the team member module 130 Likewise, the content module 122 and process module 124 may contain portions of their executable instructions that train both the surrogate module 120, and the team module 130 to navigate through and harvest from any known website the desired information.

In certain embodiments, the surrogate module 120 may include a predictor 126 that may predict, such as by referring to previous data, previous experience, and information concerning content, processes, or both obtained by the content module 122 and process module 124. The predictor module 126 may automatically fill in information regarding any data that the team module 130 is tasked to accumulate.

The corrector module 128 may also provide reminders such as setting flags, providing warnings and displaying to a human intervenor 101 highlights that will suggest checking or verifying the accumulated information that has been filled into a record by the team member module 130. Thus, the actual team member 101 or intervenor 101 who is operating the harvester module 100 may see flags from the corrector module 128 filing in or suggesting inputs or asking cross examination questions as to the veracity, correctness, or the like at any particular process step or content.

Other modules 132 in the surrogate module 120 may be tasked with other responsibilities to be discussed hereinbelow. Again, as discussed above, the surrogate module 120 may be placed in the event engine 140. It may be part of the analysis module 139, in the harvester module 100 to interact directly with the team member module 130 and the human being intervenor 101 operating the module 100. It may be placed in both, in some version, in order to allocate responsibility, and provide the processing timely to the database 150 and the harvester module 100.

The team member module 130 may be responsible to deliver to the event engine 140, most often, transient information accumulated by the transience module 136. Typically, such information will come from an event module 97, constituting a website affiliated with an event. The event module 97 may be hosted on a website of a promoter computer 76, a venue computer 82, or the like. Typically, the team member module 130 will develop a list of event modules 97 to be checked on a regular basis to download event information to the transience module 136.

The consolidation module 138 may be responsible to consolidate information from the inheritance module 134 and the transience module 136 to provide and support a dynamic record in the database 150. Thus, the database 150 may be maintained timely with a minimum of effort because the consolidation module 138 may immediately draw persistent data through the inheritance module 134, and combine it with transience module 136 outputs to make dynamic information that is still timely.

In the illustrated embodiment, the analysis module 139 may contain several modules. For example, tracking the processes and content delivered by a harvester module 100 may assist in analyzing the performance of the harvester module 100, and the human intervenor 101 verifying content from module 122. Likewise, the analysis module 139 may include all or part of a surrogate module 120. The analysis module 139 may also include all or part of analysis information of a situation analysis module 152, discussed hereinbelow. Administrative responsibilities conducted by the administrative module 135, may include numerous overhead activities required by the event engine.

Other modules 136 may handle other functional responsibilities of the event engine 140, some of which are unique and some rather rudimentary. For example, the administration module 135 and other modules 136 must process transactions, upgrades, associating various information with events in records in the database 150, and the like. However, the principal functionality is completed by the inheritance module 134 interacting with persistent data, the transience module 136 interacting with temporary, transient data, and the consolidation module 138 managing to combine transient and persistent data into a dynamic database 150.

The broker module 148 is illustrated in this embodiment as a separate entity. Brokering information may be a significant function to provide situation analysis to a commercial module 110 associated with a commerce computer 90 of a business. Situational analysis has been used by military organizations to provide a synthetic landscape, for example. Instead of numbers and graphs on a screen, a landscape, building, map, or the like may be provided, to give context to an event, accident, fire fight, engagement, obstacle, or other activity at a location. A human being can absorb a picture much more quickly than text, and may absorb more information with a map showing a location of an event. Thus, a driver, for example, may circumvent or go to a blockage, disabled bridge, debris, or combat activities at a particular location by navigating a model of terrain, roadways, or the like, overlaid with a description, marker, or the like showing the location of the obstruction or other activity.

In an apparatus and method in accordance with the invention, however, the situation most desired by the commercial entity 90 hosting the commercial module 110 is a description of who or what types of people and their state of mind will be at what locations. Heretofore, it has been impossible to determine why people were at a location on a street Likewise, the demographics other than a general city traffic demographic were not available. In an apparatus and method in accordance with the invention, a situation analysis module 152 may have a fact module 153 that evaluates and determines who, by type, number, and any other parameter that may be associated with people as attendees. Where parties will be, near an event venue, why, and explicit or implicit state of mind, may be known. For example, venues may host a rodeo one day and a basketball game another. The demographics for attendees at two such events may be substantially different, for a rock band concert again different. The fact module 153 processes information obtained from the database 150 and event engine 140 to assess key facts of a situation.

An inference engine 154 may be part of the situation analysis module 152 to draw inferences, conclusions, comparisons, and the like among the facts. The communication module 155 may provide the output of the situation analysis module 152 back to the commercial module 110. In some embodiments, the situation analysis module 152 may include other modules 156 to provide other analyses of interest to the processing by commercial module 110. For example, in one embodiment, a dynamic targeting module 160 may include an analysis module 157 operating on the information requested by commercial module 110 Likewise, the verification module 158 may then communicate a specific type of information. Whether the situation analysis module 152 and dynamic targeting module 160 operate as a single unit, or as separate units, the situation analysis function of the module 152 may be thought of as determining the facts and inferences. The targeting module 160 provides the functionality or logical execution of analysis steps to determine the significance of facts from the situation analysis module 152 to the advertising priorities of a commercial module 110.

To this end, the commercial module 110 may include entity information 161, and manage and serve up information regarding the commercial entity that hosts it. A commercial module 110 may be embodied within the system 92. However, for the sake of understanding the responsibilities, the commercial module 110 is shown here as a system of executable instructions hosted on a commercial computer 90, or as part of an independent commercial enterprise software module 110. The commercial module 110 may manage a list, description, images, video, and other presentation of products and services. Likewise, an advertising criteria module 163 may provide advertising criteria associated with various products, services, or the like. For example, certain products or services may appeal to specific demographics, needs, or attitudes. Advertising criteria 163 may be used by the analysis module 157 to dynamically target for the commercial module 110 particular targeting information based on data about a particular event 97. For example, a rock concert at a venue may result in attendees stopping at a pizza parlor before or after, seeking memorabilia associated with performers 105, or the like. Accordingly, such products or services may be served up by the products and services module 162, according to the module 163 advertising criteria by which such products and services will be best advertised at or near the a venue 82, 102

A commercial module 110 may include its own processing software 164 for targeting. A targeting suite 164 may include commercial analysis, marketing information, decision processes, and the like by which advertising criteria module 163 and products and services module 162 may input information, obtain it or both. The commercial module 110 may process information, and coordinate products and services, advertising criteria, and targeting algorithms using analysis data received from a targeting module 160, situation analysis module 152, or both.

In certain embodiments, a user module 106 may be one or more modules directed to particular entities or persons. For example, a user module 106 may be an application hosted on a portable, hand-held, or desktop computing device 86. User modules 106 may be or host applications, or simply access through a browser information tailored to the owner or user. Thus, a public module 165 may present public information, to any and all users of any and all types. In some embodiments, one public module 165 may be an individual user module for prospective attendees, providing information about an event 97, served up by the event engine 140 through the servers 72 to advise a user. In fact, a user 86 may use the public module 165 to program certain information that will show up other desirable activities and commercial enterprises near a venue. An attendee may find restaurants, stores, parking garages, and the like near an event. Similarly, a sponsor's module 166 is one version of a user module 106 in which companies that desire to advertise in some relationship with an event module 97. They may interact to gather and provide information, and to provide to sponsors 84f, 166 a necessary information from the situation analysis 152. Sponsors 84f may choose to advertise certain products to certain demographics, and may choose to put certain amounts of advertising funds into sponsorships of events most likely to provide certain advertising impressions and commercial results. Sponsors 84f, 166 may correspond to commercial entities. However, in this context, sponsors 84f, 166 executing the sponsor module 166 or browsing through the application 166 may be thought of as sponsors 84f, 166 who will not necessarily be establishments at a specific commercial location. They may simply have a presence. For example, nationally advertised beverages, fast food establishments, and the like may often be sponsors 84f, simply because their brand is sufficiently ubiquitous to be advertised in association with an event 97.

Other modules 167 may be incorporated as part of the user modules 106. Typically, however, user modules 106 may simply be configured as applications, clients, instruction sets, selections in a browser, or portions of served information on a website provided to the individual entity 86, such as a public individual 86, a sponsor 84f, 166, or other 167 module corresponding to some other person or organization.

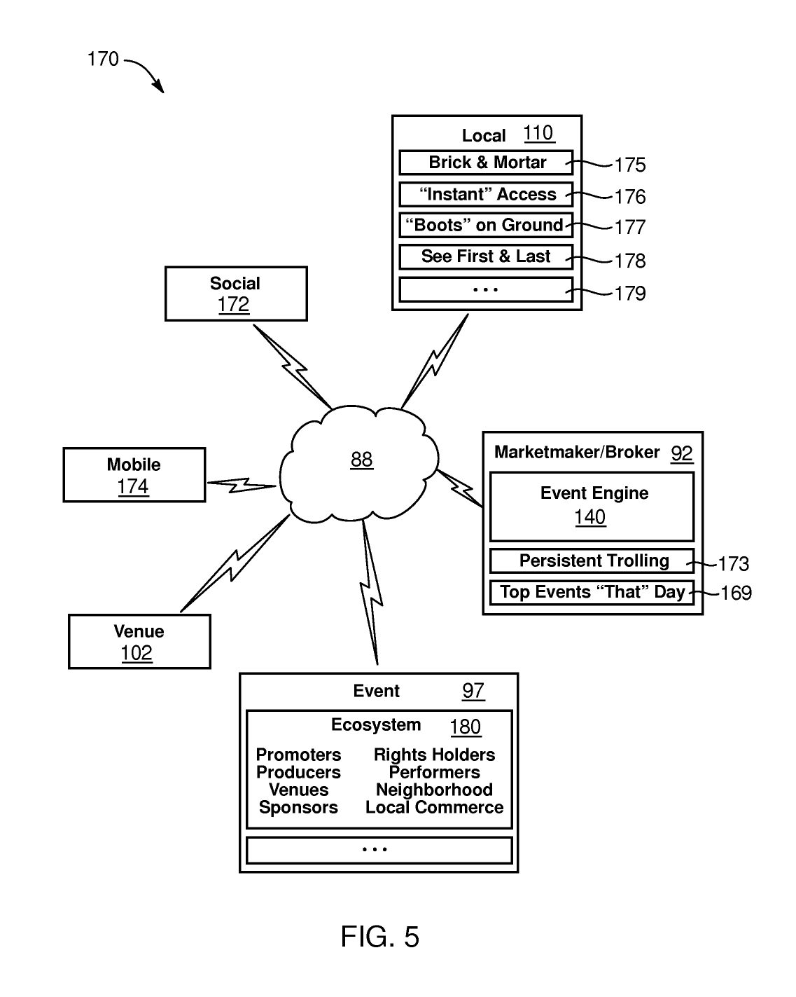

Referring to FIGS. 5 (and 1-25), in one embodiment and architecture in accordance with the invention, a social, local, mobile system 170 may coordinate social media 170 that manage social interactions, provide communications protocols and executables, and so forth. Individuals may carry with them mobile devices 86, having mobile modules 174 that perform several functions from making telephone calls to downloading web applications, surfing the internet, collecting emails, and so forth. Meanwhile, brick-and-mortar facilities 175 are represented by a brick-and-mortar module 175. The executable 175 logically functions on behalf of a brick-and-mortar institution or business as one of several local commercial modules 110. Such a local module 110 may include an access module 176 to provide instant information to individuals operating mobile executables 174 on mobile devices 86, and interacting with the social module 172 corresponding to the executables of a social communication website, such as Facebook™, MySpace™, LinkedIn™, and so forth.

Likewise, a ground module 177 correspond to the information processing actually done at the location. Moreover, a see module 178 provides information regarding what may be seen, purchased, and so forth. Thus, a local module 110 may have the management computer 175, website or mobile access module 176 to feed information to users 86, ground application 177 for use in the facility, and a see module 178 to show products, or services. By serving up from the see module 178 pictures, videos, and other enticements, the local module 110 may attract more attendees from an event 97 who are in the neighborhood of the local module 110 and its associated structure, business, and personnel. Meanwhile, an access module 176 may be a website, application, or simply a link sent by email, text, or the like in response to a poll request from an individual user on their mobile device 86, 174.

In some embodiments, the ground system 177 may be pertinent to the employees, just as the see module 178 may be pertinent to potential shoppers. However, the ground module 77 may provide for personal interactions between a user associated with the local module 110. For example, an employee or proprietor affiliated with the local module 110 may provide interactive communications through the ground module 77. Whereas the brick and mortar module 175 may involve any parts of the business including the main website, a ground module 177 may be thought of as a module that interacts with a person or human being at the site of the local module 110, providing the possibility for interaction, responses to questions, and the like. Thus, the ground module 177 may be contacted by a user or mobile device 174, to get up-to-the-minute information. Likewise, the see module 178 may give up-to-the-minute views, information, and the like on products or services. Thus, a business entity or commercial entity affiliated with the commercial module 110 may begin an interaction with an attendee on the way to, on the way from, or at a venue 82. Early, timely, interaction may draw that attendee in. Other modules 179 may facilitate other processing of information, communications, and the like, for the local module 110.

The market maker 92 or broker 92 may include two specific functions. One is the making of a market by providing information on events. The market maker function corresponds to collecting and distributing event information, typically by way of event calendars 272. The broker function corresponds to the providing to commercial modules 110 information that will be useful for timely, temporary, highly targeted marketing. The brokering function may be a subscription-based function in which the broker module 92 provides the local module 110 with attendee information enabling the local module 110 to advertise online, at the brick and mortar location, or both to provide access, interaction and direction, as well as showing wares, services, or the like. The market maker/broker module 92 may embody the entire event engine 140, or may manage it remotely. In addition, the entire system 92 may typically be embodied in a suitable computer, the cloud, or other distributor computers affiliated with the market maker/broker 92.

A persistent training trolling module 173, a top events module 169, and the like may be provided to respond to advertising criteria or other information received from the local module 110, and of interest, as a result of the event 97. Meanwhile, the trolling module 173 and top events module 169 may also serve up to the individual consumer 86 or user attendee summary 86 information about the local module 110 associated with the commercial enterprise 90 or commercial enterprise computer 90.

The event module 97 may include an ecosystem module 180 responsible to communicate correctly with various entities, their computers, their host software, and the like. For example an event 97 develops and ecosystem that includes promoters 76, 96, producers 84c, venues 82, 102, sponsors 84f, 166, rights holders, performers 105, neighborhood, local commerce 90, and the like. Accordingly, the event module 97 may interact directly through an ecosystem module 180 with any one or all of these entities or their respective computers as described hereinabove. In other embodiments, the event module 97 may be entirely incorporated within the event engine, in order to provide such information independently as a service.

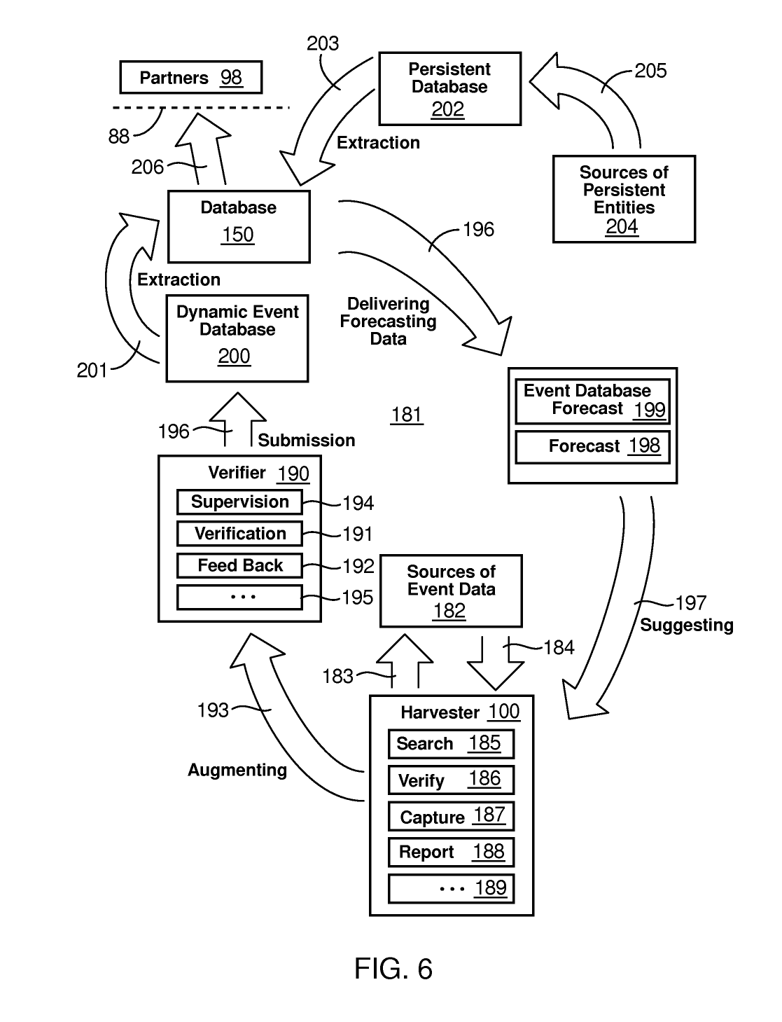

Referring to FIG. 6, a process 181 is shown in one embodiment for implementing hardware, software, and relationships in accordance with the invention. For example, a source module 182 may represent sources of event data such as promoters 76 putting on an event. Sources 182 may be represented in numerous locations, and instantiations. For example, a harvester module 100 may return 183 to a source module 182, and regularly download 184 information. The harvester module 100 may include a search module 185 to search for certain information Likewise, a verify module 186 may present to a human intervenor certain information in an interactive display for verification and editing. Many items of information may be acquired by the human mind very quickly, and may evaluated for their logical or factual correctness. A capture module 187 may capture the information, and place it in templates, records, buffers, or other locations to capture the information from the source module 182. A reporting module 188 may provide administrative functionality to upload information from the capture module 187 for eventual use in the data base 150.

In the illustrated embodiment, a verifier module 190 may correspond to a supervisory person or organization responsible for the harvester 80, 100. The verifier module 190 may include a supervision module 194 interacting, training, managing, communicating, grading, ranking, compensating, or the like according to the accuracy, output, and so forth of a harvester module 100. Similarly, a verification module 191 may provide flags, analysis, questions, statistics and other analytics reported 199 by the harvester 100.

For example, errors may be flagged when information is too long, duplicative, inconsistent, or the like. A feedback module 192 may provide information back to the harvester module 100 concerning performance, accuracy, production rates, and so forth. Other modules 195 in the verifier module 190 may help manage the harvester 100, and records to be submitted to the dynamic event database 200 to which submissions 196 will be made. The functions of errors and their correction will be discussed herein after.

The dynamic event database 200 includes event information which may then be extracted 201 to the database 150. Together with the persistent database 202 of information from persistent entities, information that will tend to be persistent, such as that corresponding to venues, businesses, entities, commercial entities, and the like may be extracted 203 and provided to the database 150. The database 150 then becomes a consolidated database 150 that is self dynamic. It can be associated, updated, refreshed, and served up comparatively rapidly because the persistent database information 202 may quickly be extracted 203, on demand, and need not be searched out for every event in the dynamic event database 200.

For example, persistent data may be maintained separately in a persistent database 202, while the dynamic event database 200 may be comparatively small, thus each database 200, 202 is customized and optimized according to what it can do best. One 202 can save large amounts of data and serve it up quickly and the other 200 can accumulate the dynamically available data. The database 150 associates it with the persistent data to form a responsive database 150. The database 150 may deliver 196 information to an event database forecaster 199, which may produce a forecast 198. For example, events may happen every year, or on a certain schedule. Events 97 may happen irregularly, but in association with certain other events, seasons, holidays, or the like.

Thus, an event forecaster 199 may track the database 150, and use the delivering 196 of forecasting data to prepare a forecast 198 predicting when events 97 will recur. Suggesting 197 to a harvester module 100 that certain events should be coming up, will enable the harvester to operate more intelligently. That is, the forecaster module 199 may be part of, in addition to, or function similarly to, a surrogate module 120 in providing suggestions to a harvester module 100. The suggestions 197 may be presented in a pre-filled template, for example, or may be used to pose questions or reminders to an individual intervenor 101 operating a harvester module 100, or the like.

Ultimately, a partner module 98 somewhere across the internet 180 will receive delivery 206 of the information for the database 150. Typically, information will be delivered by way of a filtered calendar 252 by the module 109, which the partner module 98 may incorporate into a website for access by the public.

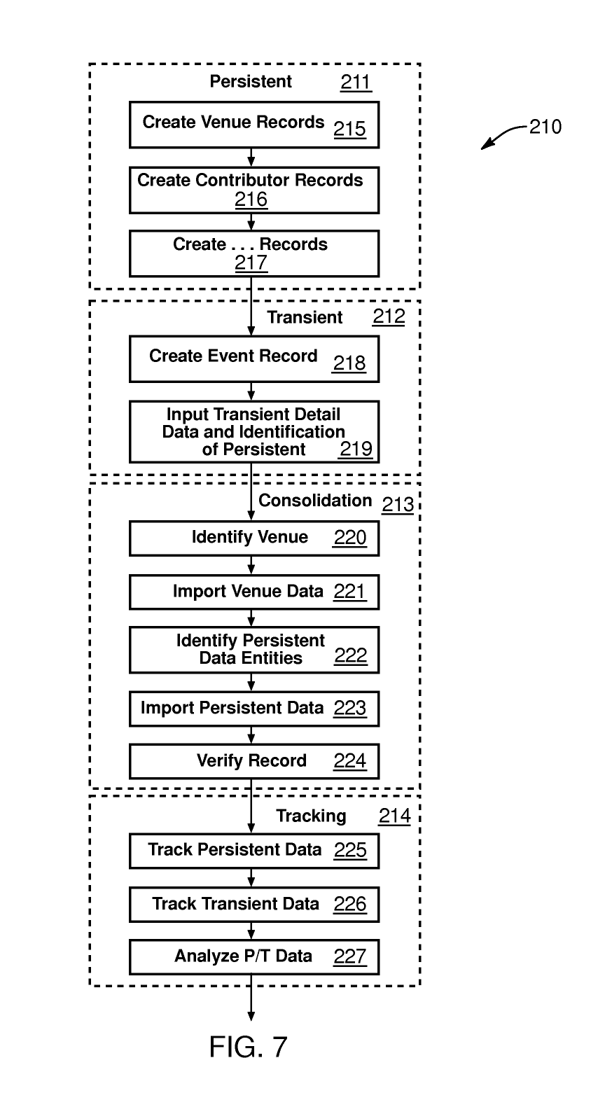

Referring to FIG. 7, at least one embodiment of a method in accordance with the invention may involve a persistent step 211, a transient step 212, and a consolidated step 213, followed by a tracking step 214. In the illustrated embodiment, the persistent step 211 may involve creating 215 venue records likewise, creating 216 contributor records may create records for the persistent database 202 for eventual incorporation into the system database 150. In addition to creating 215, 216 records corresponding to venues 82, 100 and contributors 84e, 104, other creation modules 217, or other modules 217 may be part of the persistent step 211. Those sub steps or internally contained steps 215, 216, 217, may be directed to populating the persistent database 202. Meanwhile, a transient step 212 may include creating 218 an event record, and inputting 219 transient detail data and identifiers of persistent data that will correspond to the transient data created 218 in an event record. The transient step 212 is directed to collecting details of an event 97 and associations, which may be highly transitory, with the persistent elements of the event 97.

For example, an event may be a once-in-a-lifetime occurrence. However, it is most likely that the venue 82, 102 with which such an event 97 is associated will exist for decades if not centuries.

Thus, inputting 219 details of data and identifiers of persistent data requires little of a promoter 76, 96 or event harvester 80, 100, yet makes an association between an event 97, and other more persistent data such as that associated with management 94, partners 98, contributors, 104, promoters 96, venues 82, 102, and so forth.

A consolidated step or consolidated portion 213 of the process 210 of FIG. 7 may include identifying 220 venue 81, 102, importing 221 detailed venue data, identifying 222 any persistent data of entities associated with an event 97, venue 82, 102, or the like, and importing, other persistent data 223 associated therewith. Verifying 224 the record of data accumulated. Will typically be done by the harvester module 100 and verifier module 190. Ultimately, the data may be passed on to the databases 202, and 200, for eventual consolidation into the database 150. The steps 211, 212, 213, and their equivalents may be done separately. Nevertheless, in one process 210, the persistent data may already be accumulated, and the consolidation process 213 may simply be identifying 220, 222 and importing 221, 223 the important data to be associated with the transient data of the dynamic event database 200. Thus, the illustrated embodiment 210 may be thought of as a process for creating the dynamic database 150 supporting the event engine 140.

In certain embodiments, a tracking procedure 214 or process 214 may involve tracking 225 persistent data, tracking 226 transient data, and analyzing 227 both the persistent and transient data to feed back valuable information to an event database forecaster 199, a surrogate module 120, both or the like. For example, as discussed hereinabove, a surrogate module 120 may be part of a harvester module 100, or may be one of the other modules 136 in an event engine 140. It may be embodied within the analysis module 139 thereof. In other embodiments, the surrogate module 120 may be embodied independently to track and train the actions of the harvester module 100 as it is directed on its way. Thus, the harvester module 100 becomes “smarter” over time, due to the surrogate module 120 providing more information, more direction, more pre-screened inputs, auto-filled records, suggestions, and the like to the harvester module 100. Thus, the longer an intervenor 101 continues to correct and verify the operation of the harvester module 100, the surrogate module 120 can make the harvester module 100 much more efficient.

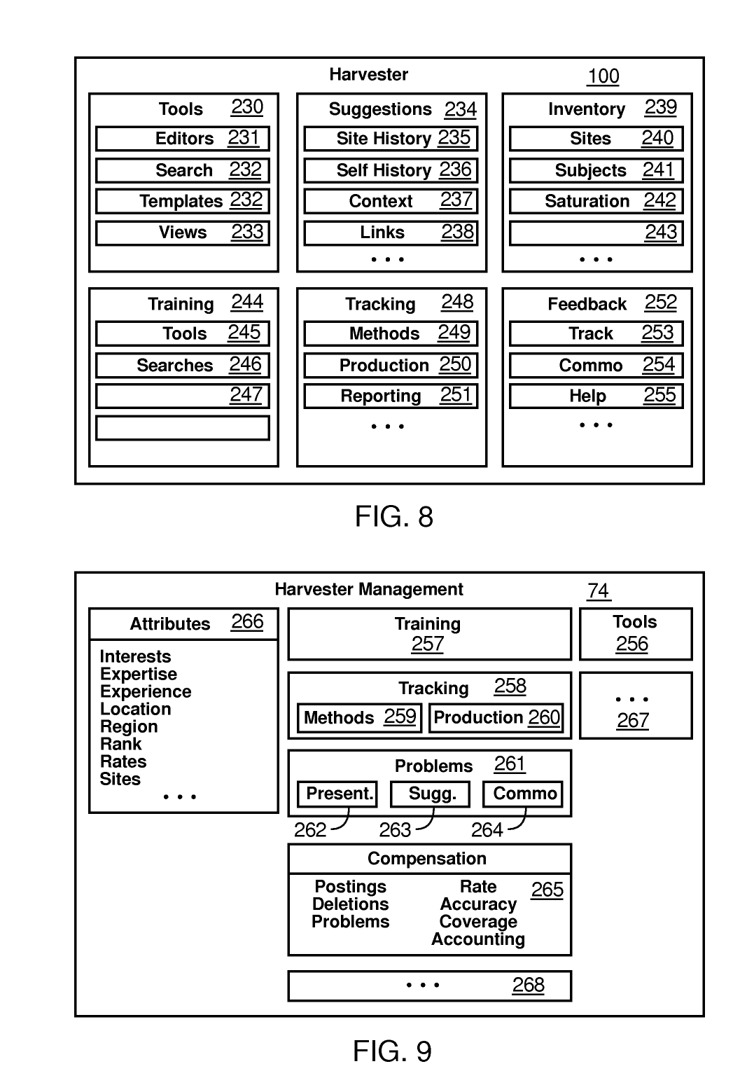

Referring to FIG. 8, a harvester module 100 may include several executables for performing the functional requirements thereof. For example, in one embodiment, a harvester module 100 may include tools 230, such as editors 231, and search tools 232. It may use templates 232 for filling in information retrieved, placing it in standardized formats, showing relative locations, providing space constraints, and the like, thus standardizing. Common editors 231 may be used for editing information in records, or within other functional responsibilities. Various viewing tools 233 for viewing information such as still photographs, videos, and the like assist in harvesting, verifying, and linking. For example, in certain embodiments, a promoter 76 may request that certain highlights, banners, marquees, or other additional advertising functionality be added to a particular event entry. Accordingly, the views module 233 may support viewing and extracting visual elements from a site to be downloaded to a record for a particular event 97.

Similarly, a suggestions module 234 may be powered by the surrogate module 120, and may include information from a management module 94 as well. In the illustrated embodiment, for example, the suggestions module 234 may include a site history module 235 for maintaining site histories of regular sites that form a “beat” that a particular harvester 100 may go to regularly to harvest event information. Similarly, a self history module 236 may track the procedure and content of a harvester 80, 100. For example, certain individuals who operate harvester modules 100 may have particular skills, interests, expertise, and the like recorded and used to assist the individual operator 101 as well as the surrogate module 120. A context module 237 may also search for and extract additional context around the normal event information to be extracted. For example, related items that are not required for an event 97 but still provide information regarding the nature of it, who might attend, interests, related events, or the like may be extracted by the context module 237.

Likewise, a links module 238 may review, extract, track, and otherwise manage links available on source sites in order that the system 70 be able to follow up on leads to other related information.

In some embodiments, an inventory module 239 may maintain a site module 240 for navigating sites, extracting information therefrom, and extracting suitable information from suitable locations found by the harvester 100, by suggestions from the surrogate 120, or from an operator 101. Similarly, a subjects module 241 may be responsible to identify subjects that may be of interest and which may relate to various events 97, as well as indicate, as by flags, certain events. A saturation module 242 may manage the completeness of searches by the harvester 100 for event information on any website. It is of particular value to be accurate in extracting event information. It is also valuable to be comprehensive in saturating all searches to assure that all information of a certain type, all activities of a certain type, all activities within a particular venue, all activities by an organization, and all events related to any of the foregoing be captured and accurately reported. Other modules 243 may also contribute to the inventory module 239. A training module 244 may include training tools 245, as well as search tools 246 for training. Other training 247 in administration, management, procedures, and the like may also be provided.

A tracking module 248 may include a methods module 249 for tracking the methods used by the operator 101 and harvester 100, including tracking the decisions, sequences, and so forth of an operator 101 controlling the harvester 100. Similarly, a production module 250 may track the production of content, quality, quantity, accuracy, precision, errors, problems, and the like Likewise, a reporting module 251 may collect, maintain, and send back to a management module 74 information that has been tracked by the tracking module 248. A feedback module 252 may provide information in a track module 253 that shows patterns, areas for improvement, areas that may be repeated and thus suitable for training the surrogate module 120 to either do more to assist the harvester 100, or learn more for incorporation into suggestions to the harvester 100. A communication module 245 may provide for communication between the harvester management module 74 and the harvester 100, as well as from the tracking module 248, and analysis engines that analyze data collected by the tracking module 248.

Referring to FIG. 9, a management module 74 may include several modules, such as tools 256. One may think of the tools module 256 as a tool box 256 of functional features to support navigation, editing, cutting, pasting, formatting, examination, analysis, parsing, or other functionality similar to that of a harvester 100. The tools 256 may also include additional management tools for corresponding with the harvester unit 100 and the operator 101 thereof. A training module 257 may include training management, as well as training selections, curricula, specific packages for training on specific weaknesses or errors that appear to be repeating according to the information from the tracking module 248, and so forth. A tracking module 258 in the management module 74 may include a methods module 259 for tracking, processing, analyzing, and reporting information regarding methods. Similarly, improvements, that may be adopted by the surrogate 120 may also be included.

Similarly, a production module 260 may monitor and analyze production information from one or more harvesters 100 working under the supervision of the management module 74. These may include tracking, recording, analyzing, and suggesting improvements based on information tracked in the production or methods used by a harvester 100, its operator, or both.

A problem module 261 may include a presentation module 262 that presents summaries, details, graphs, charts, and the like regarding problems that appear in the output of the harvester 100. Similarly, a suggestion module 263 may link to the problems reported and make suggestions for training, correction, or techniques for improving methods, production, or both. Meanwhile, a communication module 264 may take responsibility for communicating back to a harvester 100, its operator, or both information regarding the problems, solutions, and remediation.

A compensation module 265 may deal with various administrative data related to the production of a harvester 100. For example, the compensation module 265 may include information and processing of the postings, both content and number, the deletions, by content, number, type, or other related information, and the like. Similarly, problems that exist in records created by a harvester 100 may also be identified and processed. A rate, such a rate paid for each type of posting made by a harvester 100 may be included, and information or executables for processing rates, upgrading them, and so forth. These may also depend upon the operator of the management unit 74, who may provide a manager assessment.

Other accounting information such as the number of postings unpaid, the number of postings paid for, an account summary, and the like may also be provided by the compensation module 265. Compensation module 265 may coordinate with other administrative modules in an enterprise in order to track and determine output, ranking by skill and pay rate, ranking for accuracy, coverage (completeness), and the like.

An accuracy rating may be calculated as the number of added events accepted by the database 150, less the number of entries still having problems, (and thus not able to be posted), also less the number of deleted postings (that may have failed due to being duplicative, or otherwise inappropriate). That accuracy totaled divided by the total number accepted may be thought of as an efficiency or as a normalized or non-dimensional accuracy percentage or fraction.

The attributes module 266 may include processing, intake, storage, and the like related to attributes of an operator 100, and a harvester 100 under the direction of an operator. For example, interests of a person, expertise, experience, geographical location, geographical region, proximity to certain population centers, rank (which affects pay rates), rate improvement (according to quality and skill exhibited by an operator 101), and the like may be included. A series or system of sites, such as a site “beat” of standard sites that will be used by a particular harvester 100 on a regular basis may be included. Other information regarding a specialist 101 or operator 101 controlling running or a harvester module 100 may include different types of events 97, particular categories of events, or tabs (which tend to be greater in number, less restrictive, and not necessarily mutually exclusive). Categories may be general categories such as animals, sports, schools, or the like. Tabs may also relate to many other qualities including the nature of a site or an event, an age appropriateness, and the like. More will be stated about tabs hereinafter.

A rating or rank may be dependent on the quality of work, completeness or comprehensiveness, user needs, speed, amount of work and number of additional events added to the database, number of problems, types of problems, and so forth. In addition, ranking may be thought of as a promotion scale rewarded by a change in pay rate for each entry made. A specialist or operator may obtain a higher rate due to improved accuracy, as well as the additional multiplier of a number of additions made to the database.

The harvester management module 74 may include a list of problem types, which may be used in the training module 257, tracking module 258, and problems module 261. For example, bad abbreviations, web links that are broken, bad sources that are not reliable or have been black listed, a summary format, improper capitalization, incorrect admission cost, incorrect category, grammar, tag, missing recurrence information, frequency or schedule, missing tags or categories, spelling errors, subtitles used that should not be, subtitles not used that should be, titles that are incomplete or improper, particularly titles that are incorrect and thereby misleading, and the like may be included in the problems and errors. The system 70 has been found to operate best when certain sites are black listed. That is, some sites are perennially erroneous. Others are duplicative. Thus, a black list of sites considered bad sources not to be used, may be identified and provided to all harvesters 100. The use of bad sites may be flagged by the identification of information as improper, or harvested from a bad site, as an error, problem, or the like.

Other problem types may be incorrect venue, incorrect name, date, time, or title, too-long a title, too-short a title, too-long a description, too-short a description, or the like. A list of problems may include an identifier identifying a particular problem, as well as the name of the problem, the date the problem was identified, some description of the violation, as well as other information such as creation date of the event entry and other information that may be helpful for training, correction, compensation, and so forth.

Human intervention may be a valuable part of the operation of a harvester 100. In certain embodiments, the harvester module 100 in its tools 130 may provide for editing 231, searching 232, template creation or selection, reviewing views 233, and the like by human intervention. Thus, the harvester 100 may present data to an operator 101, such as a specialist 101 who is reviewing site information and sites, in order to provide for human recognition of patterns. The harvester 100 may track production content in order to watch for data relating to demographics, and any constants, such as venue 82, 102, participants (contributors 84e, such as performers, producers 84c, and so forth) as a means to provide pre-selected data packages to be saved on templates 232 rather than input manually by the user, or cut and pasted by a user 101. That is, information may be predicatively filled in and associated with events 97, inasmuch as it can be found in the persistent database 202. Thus, indicators in data on websites that are used as sources for gathering event data may be watched by the harvester module 100 for information that will tie (associate) a particular event record to persistent database records of some type.

Likewise, intelligent associations may be made due to suggestion module 234 providing information either from its own stored histories, contexts, and links, or from suggestions made to the suggestion module 234 or therethrough from the surrogate module 120. Additional tools 230 may include various analytics that identify any statistical data associated with a site, the information, the event, or the harvester 100 or the specialist operating the harvester 100.

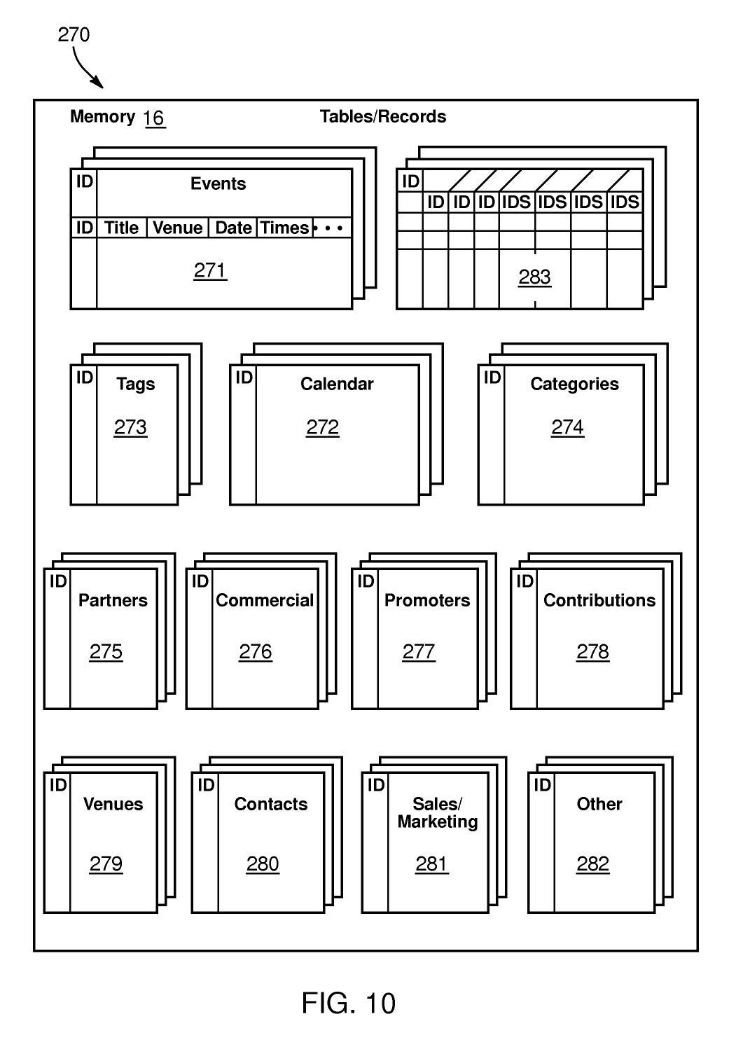

Referring to FIG. 10, the database 150 and the various other databases 200, 202 used in a system 70 in accordance with the invention may store data in various records 270. In certain embodiments, it has been found effective and efficient to use data tables. For example, a data table 271 dedicated to events may include the identification code, title, venue, dates, times, start times, end times, repetitions, and other associations with a particular event 271. Similarly, tags 273 may be saved in a database, each identified by an identification number or code. Likewise, a calendar module 109 with all appropriate information associated identified by various codes, indicates what categories of information are to be included in a calendar 272, what categories are to be kept out, what tags are to be included, what tags are to be left out or prohibited, and so forth Likewise, the categories 274 may be identified by an identifier and other information such as title, text, explanations, or the like. Meanwhile, similar tables may identify records of partners 275, commercial entities 276, promoters 277 putting on events, contributors 84e who are participating in some way, such as performers 105 and the like, with an event record 271, venue record 279, any other contacts 280, as well as sales and marketing entities or individuals records 281, and other records 282. In general, the data tables 270 may be compact by using an identifier as a leading “ID” for each record entry in a particular table 270, followed by a list of associations. For example, the data tables 270 may be configured as association tables 283.

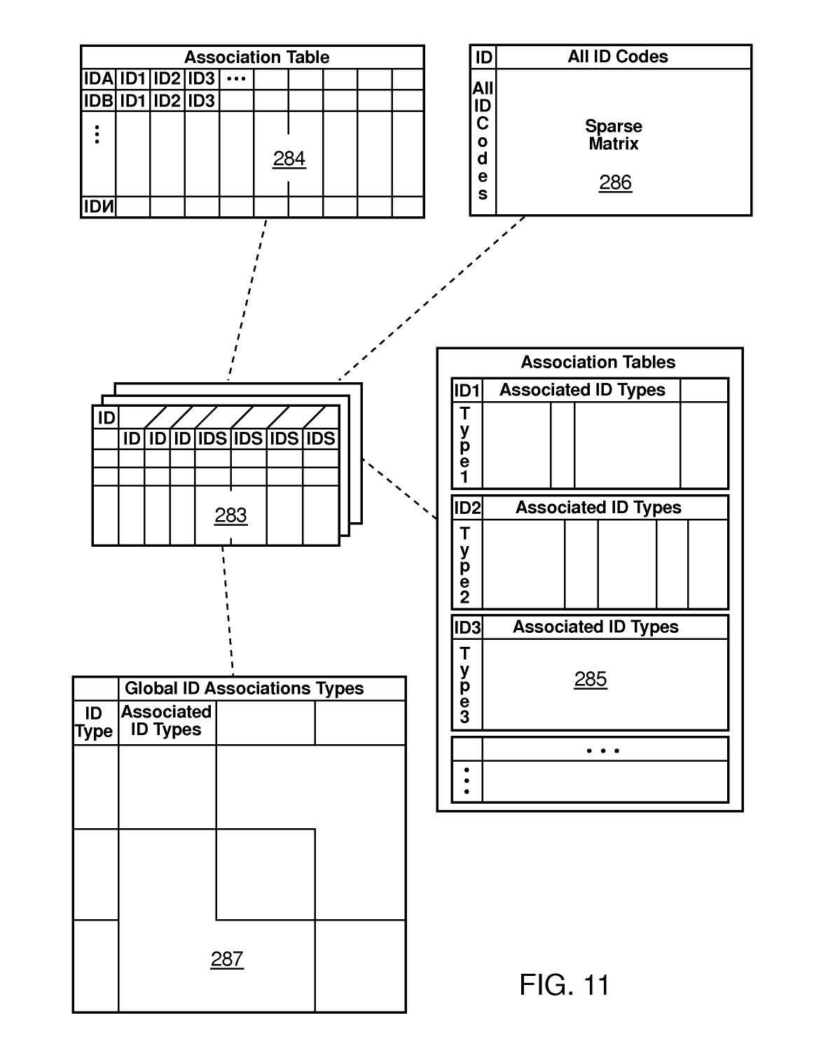

Referring to FIG. 11, association tables may be made in any of several types, depending on the density of data. For example, in one embodiment, the association table 283 may be of a direct type 284. In the direct type, and identifier 293 identifying the entity or item that is to be associated, may be followed by a simple list of delimited designations of other items held in the database that are related. These may be identified by global identifiers, or may be grouped. In the grouped system, a tailored database table may be used in which the identifier of a particular type of quantity or thing may have associated with it only certain types that are grouped together. Accordingly, the length of these records would vary according to what type of entity is to be associated with all the other items that may associate with it.

In other embodiments, a sparse matrix 286 may simply list universal codes for all items having records, and the flag for inclusion or exclusion of all other codes may be included in a matrix. In such a system, a global ID association type of table 287 may include all associated ID's. They may also be grouped in order to compact a rather sparse matrix 286. It has been found effective to use association tables in order to quickly, easily, and directly point to the global identifiers or the group identifiers of each item associated with any other item. For example, events 271 may include all data in the database as particular ID numbers for title, venue, date, times, and so forth.

Similarly, a calendar may include codes identifying for each calendar ID a list of tags to be included, tags to be excluded, categories to be included, categories to be excluded, and so forth. Records in the database may also be categorized. For example, in addition to venue records 279 and event records 271, the commercial records 276 corresponding to commerce computer 90 and their owners may be augmented by advertising data, images, text, clips, video, still photographs, and the like. Product listings, product data, and the like may even be data based.

Profile data corresponding to individuals, groups, venues, events, and persons may be included. Social media network data may be included in broadcast lists, contact lists, and so forth. Alternatively, information associated with entities may be kept in a single table with every entity categorized by what type, commercial, partner, individual, or the like. Similarly, contributor records 278 may include contributor type, such as performer, promoter, sponsor, support, engineering, facilities, equipment, radio stations, advertisers, and so forth.

In addition, GPS data may be provided in association with any of the records 270. In particular, GPS data or some type of global positioning system coordinates in longitude and latitude on the face of the earth should be associated with each event 97 or event record 271. Similarly, each commercial entity 90, 110 having a record 276 that will be used in association with certain events 97 in the records 271 will want to use global positioning data in order to determine a raise of influence, mapping, proximity, and so forth. Data may be grouped according to its persistence or transience. Alternatively, it may be flagged or identified with simply an identifier that designates a particular record as a persistent record 270 or a transient record. Likewise, tables 270 may include inference data, and the inferred result of processing inference data. Similarly, situational awareness data may be identified in its own table. Authorization data for pushing information, pulling information, sharing information, or locking up information may be included in various tables 270.

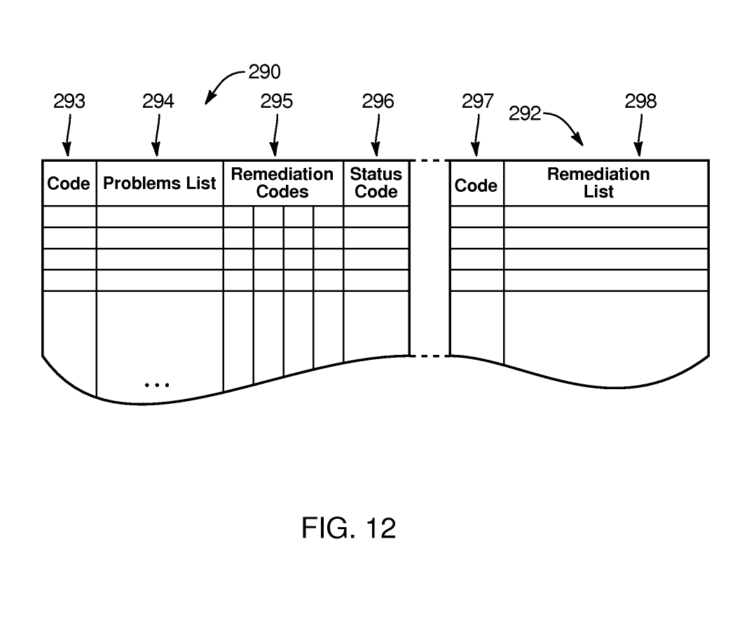

Referring to FIG. 12, a table 290 represents a list 290 or table 290 of potential problems. Corresponding thereto is another table 292 or list 292 of remediations, solutions that may be undertaken by supervisor, but typically by a specialist or operator associated with a harvester 80, 100. In the table 290 is a list of identification codes 293, or simply ID codes 293 and problems 294 by title, description, and so forth. Meanwhile, associated with each code 293 associated with a problem 294 is a list of remediation codes 295 that correspond thereto. The remediation codes 295 identify remedial measures that may be used to solve any problem 294 listed. Fields 296 for status, updates, stage of progress, or the like may also be saved in the table 290 to indicate the current status or disposition of a particular problem 294 identified. In general, the table 290 is created into forms. Initially, a list 290 exists for the entire system 70. For example, a list 290 of all of the individual problems 294 that may be encountered, identified, tracked, remediated, and so forth may be listed.

In another instantiation, a list 290 may correspond to records 270 associated with a particular harvester 80, 100. Accordingly, a list 290 of problems 294 may be those to be addressed. Thus, the system of codes 293, 295 enables rapid communication, look-ups, navigation, and so forth by a computer system 10, 70 in identifying, tracking, saving, monitoring, and setting flags and follow up to attend to remediation of problems existing with particular records awaiting submission to the database 150.

The codes 297 correspond to each of the remediations in the remediation list 292. Typically, the codes 295 may be one or more codes, that may be single. For example, each problem 294, may be described in text, title, other mechanisms, and may correspond to one or more codes 297 placed in the codes 295 corresponding thereto. In other embodiments, each code 295 may be a single code number 297 corresponding to a specific remediation 298 from the solutions list 292.

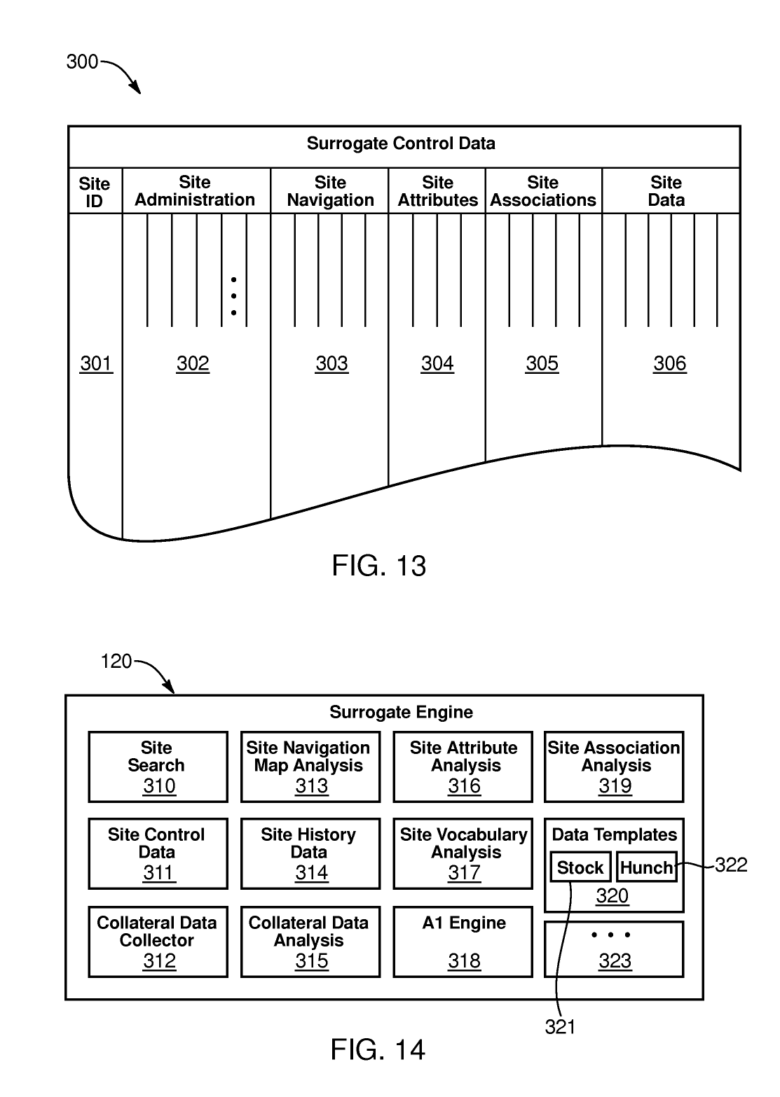

Referring to FIG. 13, the surrogate 120 may include a table 300 or record 300 of control data. Typically, control data table 300 may identify numerous site identifiers 301. Accordingly, a site administration field 302 may include site codes, such as uniform resource locators, and other identifying characteristics of a particular site. By site identifier 301 is meant a source site 182 or simply source 182 from which the surrogate 120 will extract, or assist in extracting event information. Thus, site administrative data 302 may include information to navigate to the site. Meanwhile, site navigation data 303 may include page numbers, line numbers, codes, and the like to look for. Certain attributes 304 of a site may also be saved in any suitable format in order to identify characteristics that will aid in navigation, and extraction of data. For example, the tags or categories that may apply to information extracted may be characterized as attributes 304. Similarly, any other characteristic that is useful to an operator 101 of a harvester 80, 100 or in recognizing, harvesting, organizing, sorting, filtering, or otherwise rapidly locating and extracting accurately and completely the event information, may be included in the site attributes 304.

Many sites include, references to other websites, hot links to other webpages, and so forth. Accordingly, associations 305 may include identification of associated sites that are related to, referenced by, or in any way associated with the particular site 301 being harvested. Site associations 305 permit and support branching by the harvester 80, 100, as well as by the surrogate 120.

Ultimately, data 306 from the site 301 may be saved for reporting, and for future use. For example, analytics associated with the surrogate 120 may rely on site data 306, and may contribute to site data, by way of inferences, conclusions, directions, process steps, page sequences, locations of information, context, and so forth. Thus, the site data 306 may be typically considered substantive data and data related thereto. Meanwhile, navigation data 303 may be thought of as information that will aid in navigation of the site 301.

Referring to FIG. 14, a surrogate engine 120 may include various modules. Typically, a surrogate 120 may be thought of as a super-human assistant that is both better and worse than a human for giving information. For example, the surrogate 120 may read information much more rapidly than a human being. On the other hand, a human being, such as the intervenor or operator of the harvester 80, 100 can recognize context, images, and various other nuances that would be missed by a deterministic evaluation. Nevertheless, the surrogate 120 is taught and learns by observing what is decided and done by the operator or specialist running the harvester 80, 100.

By the same token, the surrogate 120 also teaches the human operator by making suggestions through the harvester 80, 100, by way of questions, statements, hints, “hunches,” and automatic filling in of certain fields with certain information that may be harvested with a high degree of confidence by the surrogate 120 directly. Thus, once a site 301 has been searched repeatedly, and its format, navigation, layout, and so forth have been well documented and understood, the surrogate 120 may harvest the site with little or no intervention by the human intervenor operating the harvester 80, 100.

The surrogate engine 120 may include a search engine 310 for searching individual sites 301. Likewise, certain site controlled data modules 311 may use the site administrative data 302, site navigation data 303, and even the site attributes 304 in order to direct the search engine 310, and the extraction processes. The collateral data collector module 312 may also pick up additional information that provides context. For example, human beings often recognize relationships that are not numerical, may not appear to be deterministic, and so forth. Typically, words, images, order, and other contextual information may be found with particular data. Accordingly, a collateral data collector module 312 may collect additional data that may provide context, or clues to additional navigation.

An analysis module 313, is directed to site navigation map analysis 313. This may use the site navigation data 303 in order to proceed to particular locations. However, the site navigation map analysis 313 is not tasked with the same function as the search engine 310. Rather, the analysis module 313 is responsible to note changes, observe patterns, analyze sequences, distances, various analytics about the links, formats, locations, and so forth, in order to develop patterns that can be fed back to the search engine 310 as navigation aids.

A site history data module 314 may maintain and continually analyze the historical data harvested from various sites 301. A sense of history, and an analysis of that history may be provided by the module 314, in order to continue to categorize, and otherwise understand the utility of the site 301. Just as the collateral data collector module 312 collects collateral data, and analysis engine 315 for collateral data may also be included. As the analysis engine 313, this engine 315 uses data developed by the collector module 312 in order to analyze the significance, nature, content, relationship, or other information about collected, collateral data. Collateral data may include items that relate to an event, but are not the core “facts” and numbers.

An analysis engine 316 may be devoted to site attribute analysis based on attributes 304 of a particular site. Site attributes 304 may be saved in order to assist in future searches. Typically, the engine 316 may also receive data from the navigation analysis engine 313, and the collateral data analysis module 315.

A site vocabulary analysis module 317 recognized that human beings create text, and choose their own lexicon to describe certain information. Different sites 301 may use different vocabulary. Accordingly, the relationship between language, words, and other vocabulary usage may be analyzed by the module 317, based on the foregoing data collection and analysis engines.

An artificial intelligence engine 318, including inference engines, fuzzy logic engines, and the like may be included in the surrogate engine 120 in order to deduce non-deterministic information. Again, pattern recognition may often be developed from collected numbers. However, many analyses, regressions, curve fits, and the like may be applied to numbers without obtaining certain other information that can be inferred. Accordingly, an artificial intelligence engine 318, including various types of engines may be used to analyze any available data, text, and even images found on a particular site 301 used as a source 182 for event data.

In certain embodiments, the artificial intelligence engine 318 may be of particular value in assessing or deducing a state of mind. That is, for example, knowing the number of people, the demographic information, the nature of an event 97, and so forth at a particular venue 102 may be more tractable than certain subjective information. For example, some sites permit commentaries, discussions, include blogs, or the like. Much may be inferred about the state of mind independent from the numbers that characterize an event. Names, addresses, numbers, ticket prices, and so forth are numerical in nature. However, attitudes, mental situations, and the like may also be inferred by the artificial intelligence engine 318, and based on collateral data, vocabulary analysis, and the like. Thus, in terms of providing a situational awareness, demographics, event types, and the like may provide certain inferences, which may be done by the engine 318. However, in addition, the collateral data may also provide additional inferences which may be very valuable to the situation analysis module 152.

A site association analysis engine 319 may be responsible for analyzing a significance or otherwise following up on information related to associations, typically about the websites, but also of other names, statements, words, and the like used on website 301. A selection of templates 320 may be effectively used by a surrogate engine 120 in one of several ways. For example, certain stock templates 321 may provide basic information required for an event. Events may be provided in a local news format, such as a newspaper, online news, or the like.

A certain amount of context may be implied. For example, phone numbers are often used without an area code, because an entire community or region is within a single area code. Thus, the stock templates 321 may assure that all necessary information is included, and is obtained. On the other hand, a projection 322 or hunch module 322 may also provide suggested templature. For example, additional information, inferences, and the like may be determined. Thus, the hunch template 322 may be used for information that is not necessarily determined absolutely, but is suggested. Thus, in certain embodiment, the hunch 322 may actually duplicate a stock template 321, but be a suggested template 322 somewhat different, incomplete, complete, or the like, but not absolutely determined as a stock template 321.

The surrogate engine 120 may include other modules 323 including functionalities described hereinabove. It may include various application programming interfaces (APIs) and the like for interfacing with other programs. Likewise, administration, access, control, data passing, and other overhead must be accomplished in order to communicate with, control, and otherwise make use of the surrogate engine 120.

The surrogate engine 120 may be thought of as an intelligence collector. It may track various sites, where information is located on particular pages, what line, what codes, or other characteristics may be found, timing, frequency of events, types of events, how often the site is updated, how information is stored, formats, various codes or keys needed, and the like. Thus, the engine 120 is set up to be able to provide not only tracking and evaluation for events, to get accurate, complete, and comprehensive download of events, but also to evaluate other parameters. For example, the source, the contributors, the venues, and so forth associated with a particular site 301 may tend to become repetitive, or establish patterns. Recommendations and suggestions, preliminary searches, and the like may be passed to the harvester 80, 100.

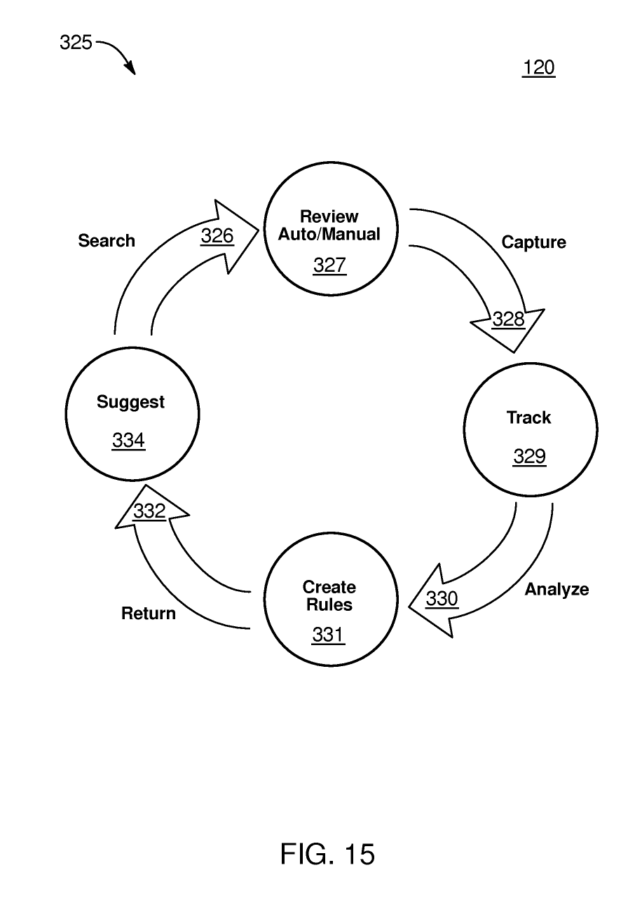

Referring to FIG. 15, in certain embodiments of an apparatus and method in accordance with the invention, the process 325 may begin with a search 326. The search 326 may be done by the harvester 80, 100 but may begin with a search by the surrogate engine 120. In fact, the search 326 may include searches by both. Ultimately, a review 327 occurs. This review operates in the harvester computer 80, and involves a human being as an intervenor acting to assure that the information is legitimate, accurate, complete, and so forth. For example, misspellings may or may not be picked up. Likewise, words may be considered misspelled, but be actually correct. Some may be misspelled intentionally for grabbing attention, may pertain to different or foreign names, or the like. Ultimately, the review 327 then results in capture 343 of the information. Tracking 329 then occurs by the surrogate 120 continuing to track the data being harvested from a site 301. Analyzing 330 may include both automatic and manual analysis of that information.

Over time, with the accumulation of data, creating 331 certain rules may assist both the intervenor 101, the harvester 80, 100, and the surrogate 120 in future searches. Those rules may be fed into and returned 332 both as rule suggestions and implemented suggestions. An implemented suggestion is suggested information, based on a rule. Suggesting 334 inputs, questions, pre-filling fields, pre-filling entire records, and the like may be included. Ultimately, additional searches 326 may be done according to a particular schedule, and according to the rules created 331 by the surrogate 120.

The database 150 may record the information relating to sites, events, venues, and other information described with respect to FIGS. 1-25. In certain embodiments, reports may be fitted into templates 320, and may also be posited as questions, cross-examination of actions taken by the harvester 80, 100, and so forth. In addition, the surrogate 120 may also be programmed to go to the database 150, and pull records, in order to analyze those records to determine patterns.

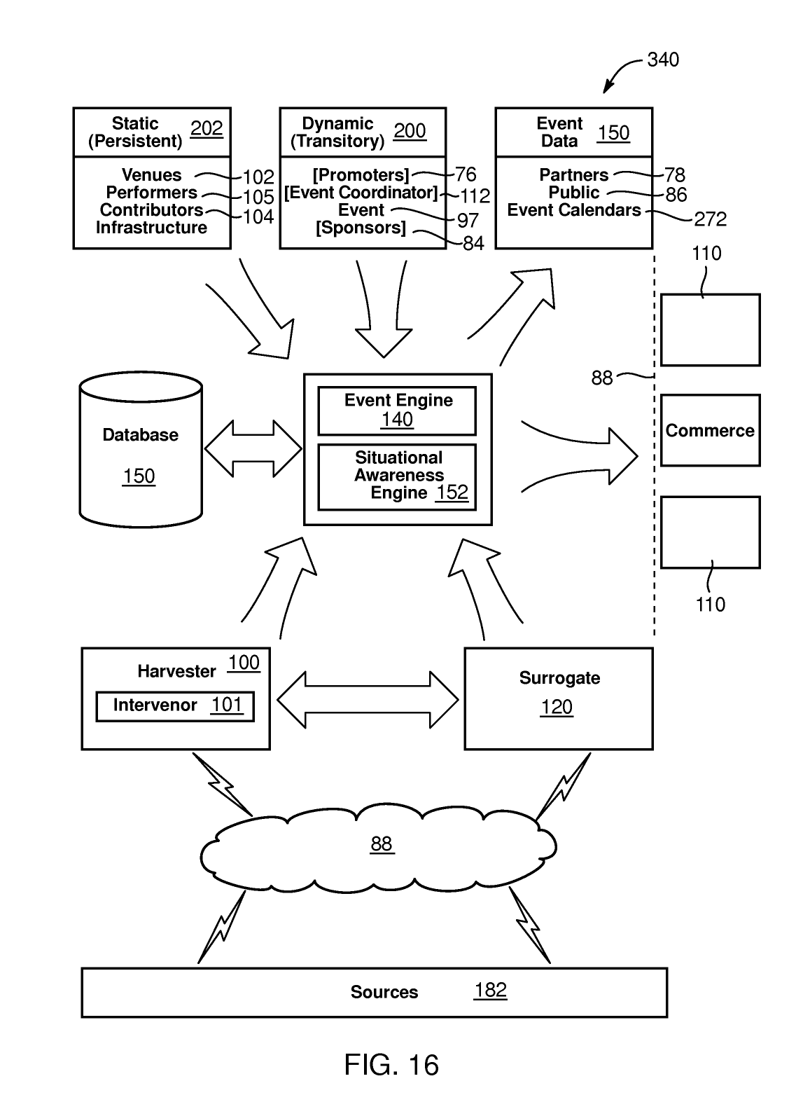

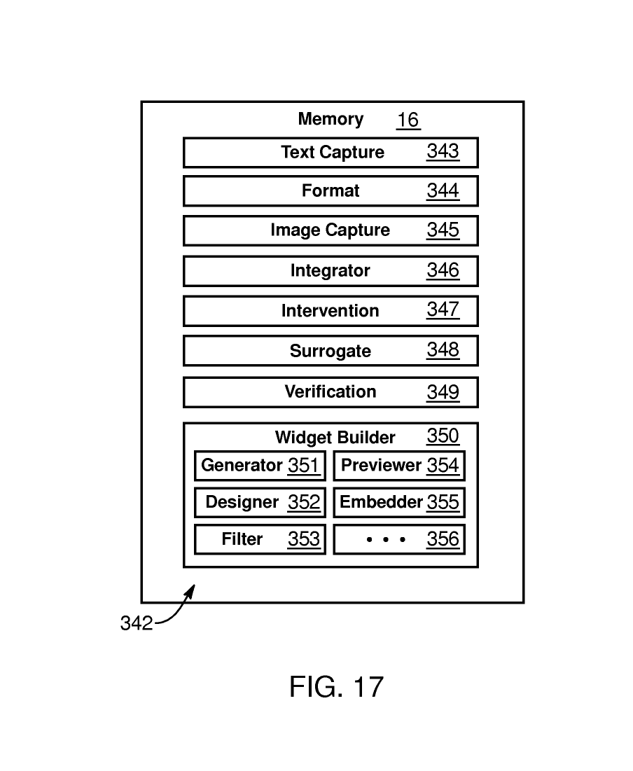

Referring to FIGS. 16 and 17, while continuing to refer generally to FIGS. 1-25, a system 340 or process 340 may involve static or persistent operators or modules, such as venue module 102, performer module 105, contributor module 104, and other info structure modules, and the like. Similarly, dynamic or transitory entities and modules may be thought of as promoters 112, event coordinators 112, events 97, sponsors 84, and so forth. The most transitory entity and module is an event 97. Promoters 76, 96, or other coordinators, may be engaged in a single event 97. Sponsors 84 may also be enlisted for a single event 97. Promoters 76, 96, and event coordinators 112, may be thought of together as promoters, tied to the event 97, as creators “putting on” the event 97. Sponsors 84, 104, elect to contribute in some way to the event 97, for their own purposes, such as philanthropy, advertising value, or the like. Sponsors 84, 104, may, for example, include local institutions, businesses, philanthropic organizations, or the like.

Regardless, the dynamic or transitory data 200 is not as clear cut, because some promoters 84, 104 or businesses 90, 110, schools, other institutions, and the like, persist over long periods of time. Thus, producers 84c, promoters 76, 96, sponsors 84, 104 and the like may actually persist within the static or persistent data 202 of the database 150. Event data combines the static or persistent data 202, and the dynamic or transitory data 200.

Ultimately, the database 150, will include the data associated with any particular event. Thus, the event data 150, or the event database 150 may include information on partners 78, the public 86, event calendars 272, and the like. However, event data 150 in this illustration is consolidated information including both static or persistent data 202 and dynamic or transitory data 200 that applies to a particular event 97.

The data 200, 202 is submitted to the event engine 140 for processing as described hereinabove. Data may be extracted by a harvester 100, and checked by an intervenor 101 operating as a human operator 101, specialist 101, or the like. Sources 182 may be drawn upon, typically through the internet 88, by a harvester 100, surrogate 120, or both to extract data to provide to the event engine 140.

In general, the surrogate 120, harvester 100, or a combination may provide event data 150, and particularly the dynamic data 200 to an event engine 140 for processing. The harvester 100 and the surrogate 120 may communicate as illustrated by passing suggestions and pre-filled templates from the surrogate 120 to the harvester 100. Similarly, the harvester 100, may submit to the intervenor 101 certain information for verification and ratification before being returned to the surrogate 120 for addition to its knowledge store. The intervenor 101 operating through the harvester 100 may override suggestions by the surrogate 120 using human judgment. Thus, the surrogate 120 tracks the harvester 100, and collects data in that process, and also receives information for processing in order to determine patterns, in order to learn as a surrogate 120. Meanwhile, the harvester 100 obtains suggestions from the server, and may receive completed searches from the surrogate 120. The surrogate 120 may eventually obtain a certain degree of independence and pass information directly to the event engine 140. However, this is not necessarily required nor desirable in all situations.

A situational awareness engine 152 may use analysis of data in the database 150 to provide a situational awareness data set to a commercial module 110. For example, once the analysis is completed to determine facts corresponding to an event 97, certain fixed information or persistent data 202 is known. For example, streets, buildings, store locations, and other geographic data in terms of geophysical coordinates of various businesses of various types will be known. These will typically be static or persistent data 202 and not subject to change. Thus, the comparatively transient data including the types of people, the numbers of people, and the like who have attended, or signed up to attend an event 97 may be provided as part of the dynamic or transitory data 200, all saved in the event data 150 of the database 150. The event data 150 may then be provided to partners 78, for use on their web calendars on their websites, to the public 86 directly, or through the websites of partners 78, or through event calendars 272 disseminated in any other manner.

At the same time, a state of mind of an athlete may be deduced or inferred by the situational awareness engine 152 that may use not only deterministic facts and analyses, but also fuzzy logic, artificial intelligence, collateral information, and so forth collected by the surrogate 120.

In summary, the process of collection of data may include the system 342 or process 342 of FIG. 17, with various modules stored in memory 16 of a computer system 10 in accordance with the invention. Text capture 343, formatting 344, image capture 345, integration of data, including both text, images, transitory data 200, persistent data 202, and the like may be included in integration 346 by an integrator. FIG. 17 represents modules as well as process steps. Intervention 347 by an intervenor 101 provides for an initial verification of information. Meanwhile, the surrogate 348 may previously, concurrently, or subsequently, execute 348 or receive 348 the information. Again, engaging 348 the surrogate 120 may include interactions of all the types discussed hereinabove. Ultimately, the management module 94 is responsible for final verification 349 of all data that is to enter the database 150.

In addition, a widget builder 350 may be available. The widget builder 350 may include a generator 351 to generate micro applications. A designer 352 may design the layout and format. A filter module 353 may establish filters for selecting and deselecting certain information. Meanwhile, a previewer 354 may allow for reviewing information prior to committing to it. An embedder 355 may operate to embed a widget micro application into a program, a module, an application, or onto a site or device. The embedder 355 may also put micro applications in specific pages, or within other applications. Other modules 356 may also be included in the widget builder 350 in order to accommodate the administrative functionality, as well as the technical functioning of such micro applications.

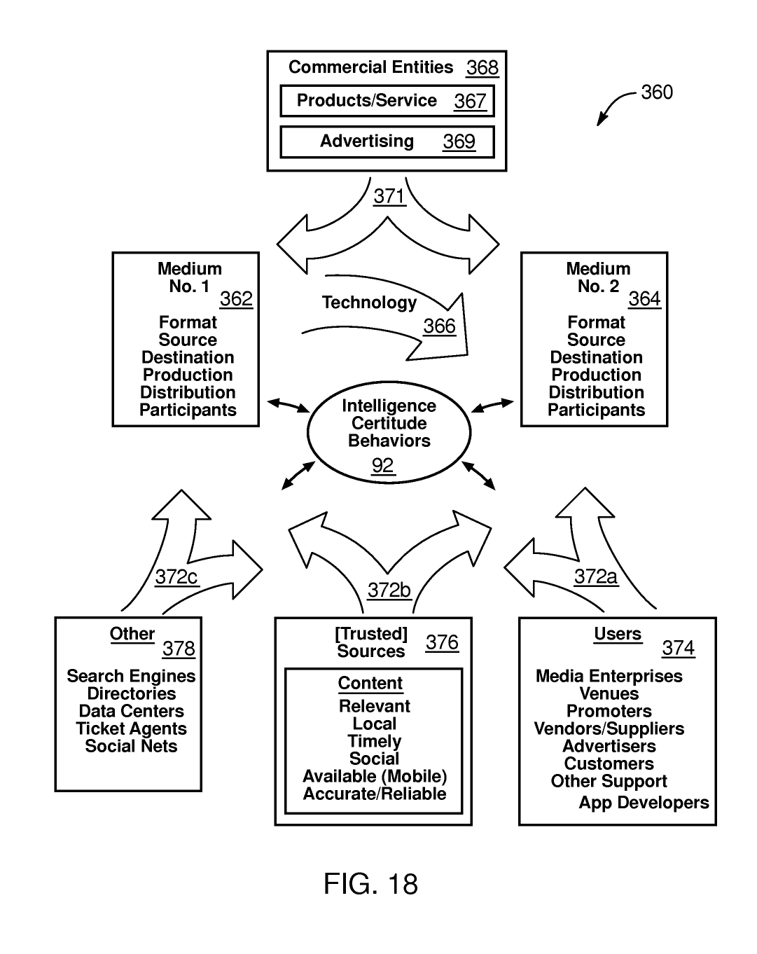

Referring to FIG. 18, while continuing to refer generally to FIGS. 1-25, a transition process 360 between media 362, 364 is often driven by a technology 366 or technological innovation 366. For example, in the modern age, print media may be thought of as a conventional first medium 362, while the computerized internet may be thought of as the second medium 364. Each will have its particular format, source, destination, production, distribution, and participants for collection and dissemination of news, information, comments, articles, advice, and so forth. Media 362, 364 are paid by subscribers, and by advertisers, such as commercial entities 368. Again, the items in FIG. 18 may be thought of as physical entities, on the one hand, as well as the computerized modules through which such operate over the internet 88 to collect, send, store, and in other ways manage information, as well as execute their own functionality.

In the transition process 360, the systems 70, 92 in accordance with the invention, provide intelligence, certitude, and behaviors that assist in the transition. For example, the media 362, 364 are provided certain benefits by a commercial entity 368 (90, 110). A commerce site 90 may desire to provide products, services, or both 367 to the public. These may be advertised through either medium 362, 364. Thus, advertising 368 may be set to either medium 362, 364 or both. With the transition due to technology 366, the infusion 371 of advertising and information to the media 362, 364 is necessarily divided. In order to be cost effective, media 362, 364 must first be relevant. No use will result in no revenue or other infusions 371 from commercial entities 367. Similarly, with the advent of the internet 88, many types of information once purchased are provided free an inducement for use and exposure to other advertising.

Thus, a system 70, 92, 370 in accordance with the invention may assist by communication between media 362, 364, and various other entities 374, 376, 378. For example, in the illustrated embodiment, users 374 have interactions 372a with media 362, 364, and may have interactions with the system 70, 92, 370. Similarly, sources 376, which are typically trusted sources 376 (the brackets indicate an optional condition of any item so marked in the drawings herein) may likewise have interactions 372b with the media 362, 364, and possibly with the system 70. Similarly, other entities 378 may have interactions 372c with one or both media 362, 364, and the system 70. Typically, users may include media enterprises, venues, promoters, vendors or suppliers of goods and services, advertisers, purchasing customers, and other support. For example, application developers may find use for information provided to or from the various media 362, 364. Likewise, trusted sources 376 or other sources 376 may provide content. That content should be relevant, local, timely, and accurate. However, in new media 364, the availability due to mobile carriers and mobile devices 86 has put additional pressure on old media 362, which cannot respond. Moreover, no longer do the pronouncements of old media 362 determine social schedules, relationships, and so forth. Thus, the system 70 provides the ability to add both a social component, and an availability component to a new media 364.

Web crawlers are used to gather information from various webpages on websites throughout the world. Due to the vagaries of language, human nature, individuality, background, vocabulary, control of the native language, and so forth web crawlers are useful primarily for flagging websites that may be related to a search conducted by a user 374. However, for actual information, crawlers have proven to be horribly inaccurate and unreliable. Moreover, due to the vagaries of language, and the nature of human beings, crawlers cannot find all pertinent information, and thus lack comprehensiveness.

In an apparatus and method in accordance with the invention, the system 70, 370 may provide the intervention by an intervenor 101 in operating the harvester 100, as well as the review by a verifier 94, 190 to assure the accuracy, reliability, and even the comprehensiveness of information gathered from sources 376. The system 70, 370 by gathering and verifying information, provides the intelligence, certitude, and the behaviors required to protect the reputation of media outlets 362, 364.

Historically, much web crawling has been devoted to finding events in order to sell tickets for those events. This has resulted in a fundamental difference between the gatherer of information, and the distributor of that information. Newspapers historically provide old medium 362 community calendars. The new media 364 often show events. However, they tend to be far from complete, having documented inaccuracy rates in double digits and much worse, and are not easily corrected. Tests have been executed by the inventors of the instant application demonstrating the inaccuracy and inability to correct those inaccuracies exhibited by the major search engines and repositories of event data in the world. The problem is simply too unwieldy. Accordingly, an event engine based on a web crawler can simply not be made to approach the perfection of logic, sensing, and accuracy in some information that a human being can provide without a commensurate infinite expenditure of money. As the errors are decreased, the cost of achieving that accuracy increases. As errors decrease to zero, the cost should approach infinity. Neither the accuracy nor the cost are currently justified for infinite nor infinitesimal levels.

However, by introducing an intervenor 101 operating a harvester 100, and providing additional verifiers 190, a submission 196 of dynamic event data 200 does approach a reliability that rivals the greatest demands for accuracy of media 362, 364.

Thus, other systems 378 such as search engines, directories, data centers, ticket agents, and social networks, may be drawn upon, and their websites may be searched and harvested by the system 70 through an army of harvesters 100 and managing intervenors 101.

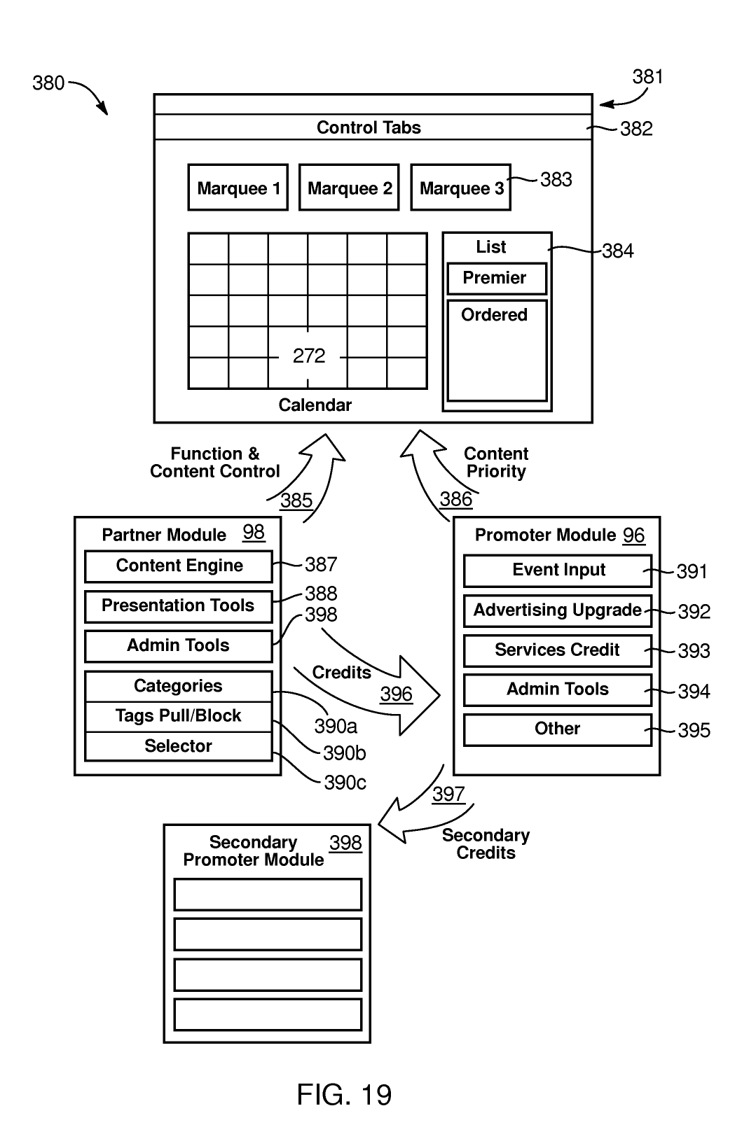

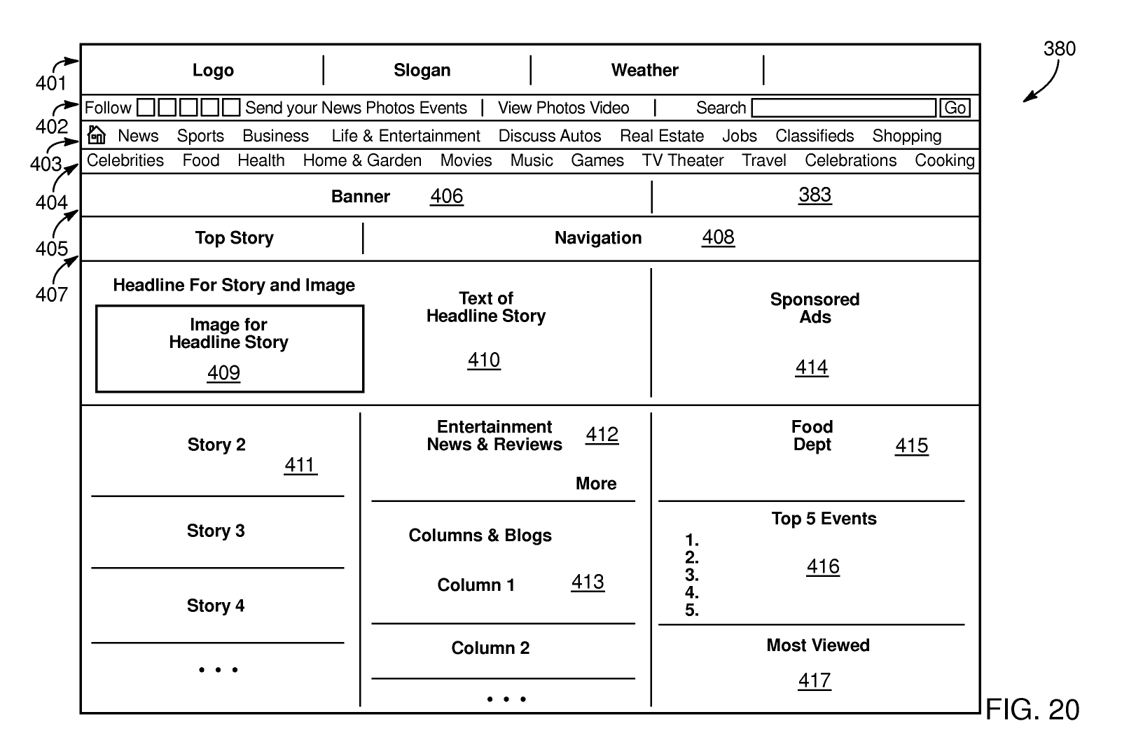

Referring to FIG. 19, in one embodiment of an apparatus and method in accordance with the invention, a screen 380 or display may appear in a window 381 of a computer monitor, television, or other display device. In one embodiment, certain control tabs 382 or control menus 382 may be provided in a convenient location, such as near the top. Typically, the site controller or owner will provide logos, advertising, and certain indicia of source at the top of the display 380. Marquees 383 may be located above the calendar 272 of events 97 in the display 380.

In one embodiment, the marquees 383 do not move if no activity is identified, such as by clicking, or by cursor movement. However, with cursor or presence movement, maximum exposure is provided by providing a change out of each of the marquees 383 in a particular sequence. Thus, the start times, and necessarily end times, of display of each marquee 383 may be staggered with respect to the other two. Thus, if an individual is attracted to a particular message on a marquee 383, that marquee can be selected to remain for a period of time, and may be clicked on to be activated, in order to be stopped. The marquee 383 may be linked to a listing and to source websites.

One benefit of an apparatus and method in accordance with the invention is that the system always maintains in the database 150 the links to the websites of all sources 182 of events. A user 86, harvester 80, 100, manager 74, 94, or the like can always click through any item displayed in the calendar 272, and arrive at the source of the information in the calendar 272. The marquees 383 are typically used by promoters 76, 96 to provide highlighted display, additional information, and attention-grabbing imagery or the like. For example, a marquee 383 may be a still or a video presentation of imagery, photographs, text, or the like.

In operation, selecting a marquee 383 by a user halts that marquee, and opens up the website, details, and the like for the promoter 76, 96 corresponding to that marquee 383. Marquee use may be provided as a benefit from the system 70, but also may be purchased as a decision on advertising by a promoter 76, 96. Again, by promoter 76, 96 is meant the entity, individual, association, or the like that is putting on an event, as well as the computer 76 in the software modules 96 associated therewith and providing the online presence and functionality over the internet 88.

The partner 78 or module 98 may be thought of as the owner and controller of the display 380, with the calendar 272 embedded. Thus, the partner module 98 provides control over the content of the calendar 272, as well as any surrounding information 384. For example, an operational function of the system 70 may provide for listings of features, transactional information, and the like in the information 384. For example, the ability to display key information, provide premiere billing, provide ordering information, and the like may be provided surrounding a calendar 272. Likewise, news, articles, and the like may be included. Nevertheless, one may think of the partner module 98 as the owner of the display 380, and the calendar 272. Accordingly, a content engine 387 may select content by selecting, blocking, and otherwise controlling what categories 390a of information, and what tags 390b characterizing information will be included. For example, a school, athletic event, play, or the like may be included as a category 390a. However, tags 390b may be much more universal. For example, the use of alcohol, drugs, adult situations, and the like in a movie, play, song, or other performance, is not a category 390a that categorizes the event. Nevertheless, it is a property, characteristic, or feature that may cause or drive a decision by a potential attendee. Thus, tags 390b characterizing events may be used by a selector 390c to control content, as may categories 390a, which are usable primarily to determine types of events 97 that one is searching for, or chooses to display in a calendar 272 by a partner 78, 98.

Presentation tools 388 may be used in order to lay out the display 380 and arrange the information, provide space, formatting, content plug-ins, image space, text space, and so forth. Meanwhile, other administrative tools 389 are available by the system 70 in order to provide the overhead activities that are required to do business with the public, do business with the system 70, and so forth. Meanwhile, categories 390a may be selected according to those by which information will be pulled into the calendar 272 and by which information will be blocked from appearing in a calendar 272. Similarly, tags 390b to which information will be pulled or blocked, may be included in a selector 390c or selector systems 390 that will operate to populate calendar 272 in accordance with the specific objectives of the partner 78, 98

A promoter 96 may have a specific interest in a calendar 272, but is responsible to provide content and priority provided 386 used in calendar 272. The function, control, and content are always provided 385 by the partner 78, 98. In contrast, the promoter 76, 96 may decide what the content of a particular event 97 will be, as well as what priority information will take. For example, a promoter 76, 96 may purchase from the system 70 a marquee 383, or premiere billing in surrounding information 384. Likewise, advertising upgrade 392 may be provided by a suitable engine 392, and services credits 393 may also be provided. For example, additional benefits to a promoter 96 may be provided to deliver additional services from the system 70 or from the site 380 by the manager 74 of the system 70, or the partner 78, 98 in the display 380 or site 380.

Other administrative tools 394 necessary for the administration, commerce, and so forth with the system 70, the partner 78, 98, and the public 86. Modules such as may enable proper navigation, selection, ticket purchasing, and the like will be valuable in that a promoter 96 is trying to provide access to services or events, while the partner 98 is providing primarily information. Nevertheless, there may be a commercial relationship between a partner 78, 98, and a promoter 76, 96 that provides some revenue sharing, which also may be accommodated by the administrative tools 389, 394, respectively. Other modules 394 as necessary may also be provided to do other necessary and desirable functions.

The transfer 397 of secondary credits and benefits to a secondary promoter module 398 may reflect a relationship between a principal promoter 76, 96, and secondary promoters 398. For example, an event may be managed by an organizer to include music by a band. The band may be thought of as a secondary promoter 398. That is, the manager, organization, or other responsible leadership for the band may want to provide additional promotion of that band, even while the event 97, itself, may be something larger or different such as a festival, state fair, or the like.

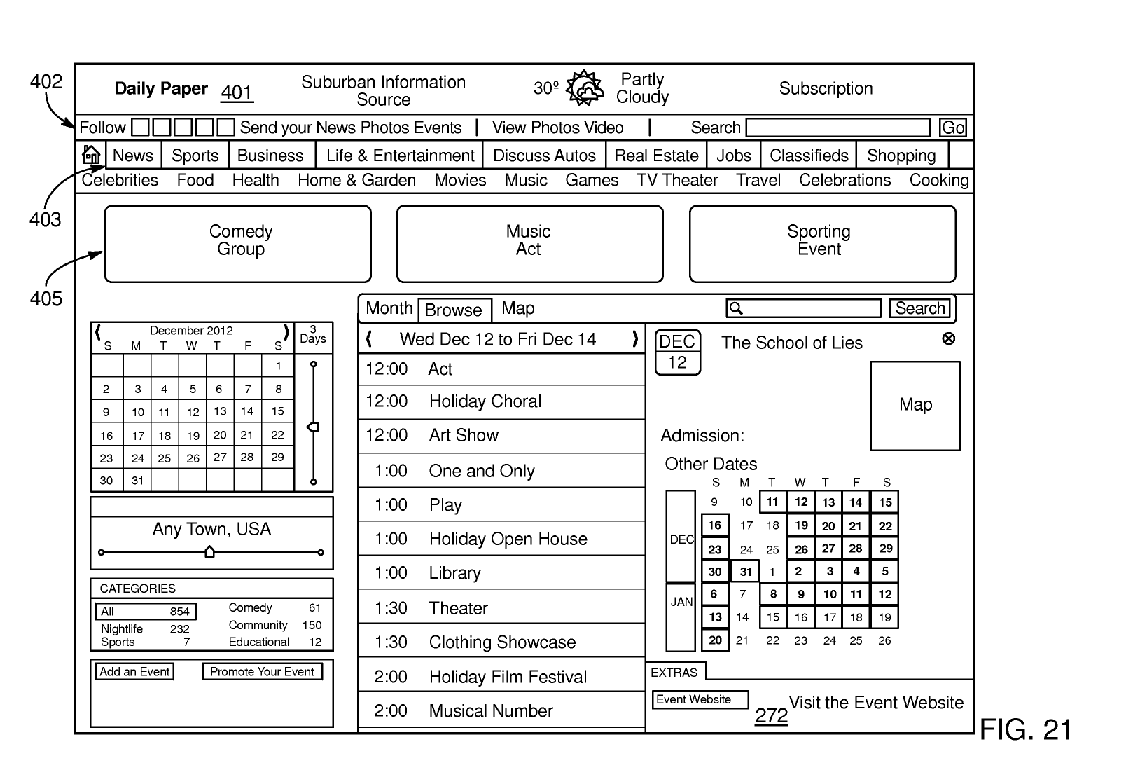

Referring to FIGS. 20-21, while continuing to refer generally to FIGS. 1-25, a display 380 or webpage 380 may be arranged according to the desires of a particular partner 78, 98 that has downloaded from system 70, and particularly from a server 72 a calendar 272. In the illustrated embodiment of FIG. 20, the partner may, for example use a flag indicating the logo, name, and other information that is typically the trademark or designation of origin of the site 380 or display 380. Similarly, slogans, and other oft-referenced information, such as weather and the like may also be included in the flag 401.

Menus 402 or controls 402 to assist in specific functions available on the site may also be included. For example, following social media, buttons to permit the public to send news or event information back through the site 380, as a collector of event information, and the like may be provided. Similarly, search engine query dialogues, and so forth may be provided as functional buttons or controls in the controls 402. Similarly, other navigation or selector buttons 403 may provide navigation about the site 380. For example, news, business, entertainment, discussions, advertisements, real estate, and the like may be identified, in order to navigate to particular displays available for the site 380.

In certain embodiments, topics 404 or topic identifiers 404 may be an extension of the navigation buttons 403, or may be distinctive from. For example, topics 404 may result in navigating two particular categories of information, standard articles, regular features, and the like.

Typically, premiere advertisements 405 will be placed near the top of the site 380. For example, the marquees 383 may take up the entire space 405. Alternatively, banners 406 providing advertising may be placed by or near the marquees 383.

The designation 407 or header 407 may assist in visually navigating. In fact, other navigation aids 408 may typically be available either as buttons, or as simply designations. For example, typically, the buttons 402, 403, 404 may act as controls. Thus, dwelling, pausing, or clicking over any particular item may cause activation and navigation to the designated topic, location, or the like. In contrast, typically, the header 407 or navigation tool 408 may be for visual navigation, in order to highlight particular information. News media will typically include a headline 410, and may provide associated graphics 409, such as images 409. Typically, a lead story associated with a headline 410 will have an image 409 associated therewith.

Other stories 411, news 412 related to specific topics such as entertainment, politics, or the like may be regular features. Meanwhile, columns 413 may be in the form of written columns, blogs, discussions, threads, and so forth. Typically, certain number of sponsored advertisements 414 may arrive from commercial entities 368. These advertisements are the traditional financial support for conventional news media 362. Various departments 415 may correspond to regular articles 413 or columns 413. Often, the departments 415 will be focused around a topic, or a featured subject, including several articles.

Meanwhile, in the illustrated embodiment, the screen 380 or site 380 does not dedicate much attention to the calendar 272. Rather, a listing 416 of top events, as well as a listing 417 of a ranking of the most popular viewed events may be provided. These may also serve as navigation aids 416, 417 in order to click on any particular event, in order to go to the calendar 272.

Referring to FIG. 21, in addition to the other features discussed with respect to FIG. 20, the calendar 272 may be presented in various pieces, and in different formats. For example, in the illustrated embodiment, lists of events are shown next to calendars themselves. Thus, clicking on a calendar may on a particular date calendar may navigate to a listing of events for that date. Similarly, the marquees 383 appear as premier ads 405 in the designated space. The calendar 272 in this embodiment actually represents several calendars, in different formats.

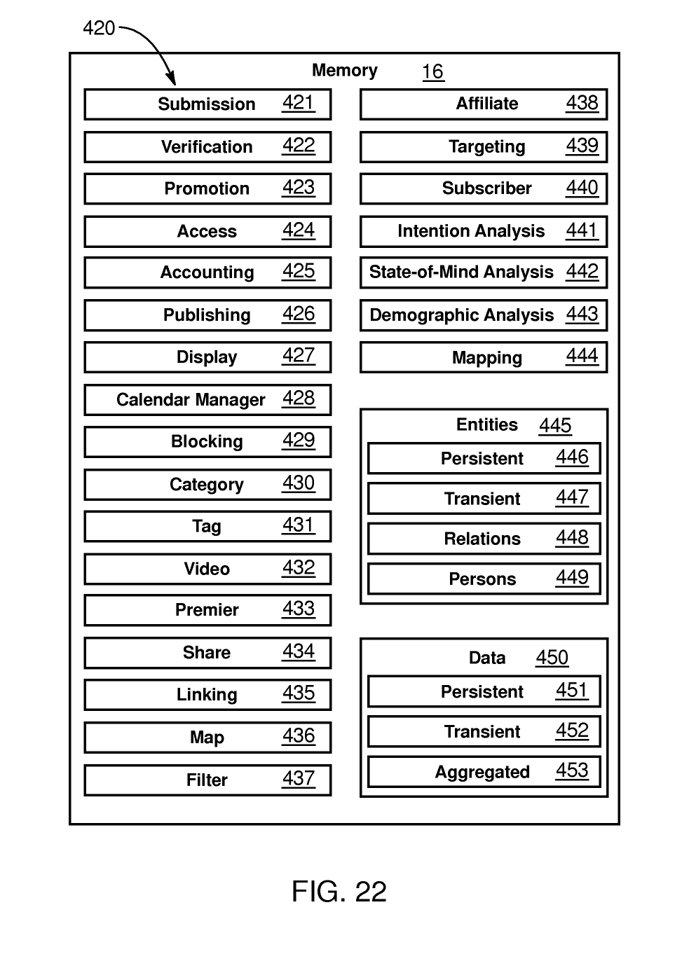

Referring to FIG. 22, a system 420 of modules stored in memory 16 of a computer 12 in a system 10 may implement various aspects alone, together, or interacting with one another as a system 70 in accordance with the invention. The illustrated embodiment indicates a submission module 422 for submitting event information through a calendar 272, or directly through any calendar 272. A verification module 422 may be responsible for providing verification of the information, such as submitting the information to a harvester 80, 100. Meanwhile, a promotion module 423 may attend to offering, and even contracting for promotional displays and upgrades of an event that is entered. Accordingly, the submission system 420 may provide also an access module for access by the promoter 76, 96 posting an event 97 for inclusion in the calendar 272. Similarly, accounting module 425 may track financial issues and process financial transactions.

A publishing module 426 may provide for the necessary functionality required to publish information corresponding to an event 97 in the calendar 272. A display 427 may provide additional display control over what and how information will be displayed.

A calendar manager 428 will typically be under the control of the partner 78, 98 who is the presenter, and therefore always the owner of the calendar 272. Thus, the blocking module 429 controlling whatever information types come up by category, tag, or both that likewise be exercised. Thus, the category module 430 and tag module 431 may be thought of as selection modules for presenting and selecting, while the blocking module 429 may be a categorical or absolute block on certain types of information. There need not be a 1-to-1 correspondence between the designations of the blocking module 429, and specific categories 490a, 430 or tags 390b, 431.

Nevertheless, the categories 390a, 430 and tags 390b, 431 are a simple way, and unlimited in that tags 431 need not be exclusive. In fact categories 430 need not be exclusive. However, they tend to subdivide, whereas tags 431 may be completely overlapping as they simply characterize properties or characteristics of information or events 97. A video module 432 may process the handling of video to be included in the calendar 272. Similarly, a premiere module 433 may deal with a premiere presentation of events 97. A share module 434 may operate to execute on the designation of sharing by an individual who visits the calendars with others. Similarly, a linking module 435 may provide for linking between calendar items and other items. Similarly, a linking module 435 may also control linking of other websites to the calendar, in order to drive users to the calendar from a website, or vice versa.

A map module 436 may operate to provide maps, typically activated without clicking, by a no-action map provision. The map module 436 provides automatic mapping of a location of a user, and its correlation with the information presented by the calendar 272. The system 70 may acquire information regarding the location of a user 86 and begin by default, providing information regarding events 97 in the proximity to the location. This may be overridden by actions of a user 86. However, it provides for automatic mapping and proximity sensing.

Various other filters may be imposed by a filter module 437, such as for filtering by the partner 78, 98, the promoter 76, 96, or other entity. An affiliate module 438 may provide interactions with the organizations affiliated with an event 97. Similarly, an affiliate module 438 in certain embodiments may provide for coordination between affiliates of a promoter 96 associated with an event 97.

Typically, marketing efforts may be improved by a targeting module 439 collecting and implementing targeting information for advertisements, events, and the like. Similarly, subscriber modules 440 may provide for subscriptions to followers who desire to follow a calendar, and event, or the like.

In certain embodiments of an apparatus and method in accordance with the invention, certain analysis engines 441, 442, 443 may be programmed to provide analysis by demographics, inference, artificial intelligence, and other mechanisms capable of analyzing all available information from deterministic to contextual, and communications. For example, individuals may follow certain Facebook sites, certain persons, pages of businesses, and so forth. Accordingly, by consent, individuals may share information related to their interests, activities, associates, buying patterns, commercial entities in which they like to do business regularly, and so forth. This may be incentivized by opportunities for discounts, sweepstakes, free goods or services, discount prices, coupons, and so forth. Traditionally, stores have held sales, provided advertising discounts, provided coupons for clipping, and so forth. With social media, such opportunities may be distributed virally by individuals who participate, and notify their circle of friends. Accordingly, consent may be obtained for collecting information selected by users.

In certain embodiments, a state of mind analysis module 442 may be used to infer from a location and other data, such as the arena or venue 82, 102 of an event, the demographic of an event, or even from personally offered information from social media sites, individual social media pages that are tracked, by consent, due to likes, offers, incentives, and the like. Likewise, an intention analysis engine 441 may infer intentions. Social media communications provide information regarding locations visited, items planned, tickets purchased, and so forth. Through the database 150, such information may be linked to analyze intentions. These may be characterized as schedules, travel directions and courses, a listing of locations during a time period, or the like.

For example, a series of events, activities, locations, or the like identified by an individual or identified with an individual may be sequenced in time to deduce a travel plan. Such travel plan thereby provides a probable course, and timing. Such information may be provided from individuals, groups, or the like.

Similarly, a parking facility may serve several venues. Those venues may be spaced at some distance. Intervening businesses will certainly be on the path between the parking facility and the venues. Thus, numbers, demographics, and even individuals, to the extent that they consent, may be identified on travel paths. This information may be used in aggregate to identify numbers, interests, proclivities, and intentions. Thus, an intention analysis engine 441 may be tasked to perform such analyses. Similarly, the state of mind analysis engine 442 may be tasked to analyze more humanistic information. For example, intentions may be thought of as plans, schedules, course of travel, timing, and so forth. Such information may tend to be (numerical, mathematical) deterministic in nature. This may be true of the inputs, the outputs, or both. In contrast, the state of mind analysis engine 442 may analyze the probable mental state of individuals. For example, a NASCAR race may last for many hours. Accordingly, needs and interests related to food, refreshment, and so forth may be different from those of one attending a one or a two hour concert. Similarly, an individual who attends a four hour professional football game may have a different mental condition than an attendee at a one hour, local school event. Similarly, they will have different locations, travel plans, and the like.

A benefit of the engines 441, 442 over a simple demographic analysis engine 443 is that the groups for a demographic analysis engine 443 may be large, anonymous, and related only by certain high-level deterministic (analytical, numeric, objective, etc.) data. In contrast, the consent of individuals, due to their interests in following a website, a purveyor of goods and services, a performer, or the like provides much additional insight into the thinking of the person. Such persons providing consent will be a much smaller portion of a larger sample population. However, these smaller sample sizes may be much more detailed, and from them may be inferred a behavior or state of mind, for a certain fraction of the overall population attending an event.

Thus, in general, the intention analysis engine 441, state of mind analysis engine 442, and demographic analysis engine 443 may be used singly, in concert, or selectively to provide information to commerce sites 90, 110 who may use the comparative pin point accuracy of information to direct advertising, coupons, incentives, and other motivators encouraging attendees at events 97 to prepare, repair, or pass by brick-and-mortar sites to obtain goods or services.

A system of entities module 445 may be thought of as the executables, programs, or the like supporting various entities. For example, an individual consumer may have a computer 86. That individual may be associated with that computer 86, identified thereby, and operates over the internet 88 and with all other websites through that computer 86. Entity modules 445 may be characterized as persistent modules 446. These correspond to organizations that tend to exist over a longer periods of time, such as more than a year, decades even, or longer. Meanwhile, transient entities 447 may correspond to ad hoc groups, virtual private networks set up for a specific purpose, event groups on social media sites that have only a temporary presence, such as weddings, participants in a rally, or the like. To a certain extent, the boundary between transient modules 447 representing temporary organizations, affiliations, and the like corresponding websites and the persistent modules 446 representing permanent institutions in sites, may be set at an appropriate level according to their utility. Thus, the division may be deterministically, by certain threshold behaviors or performances, set subjectively, for particular purpose, or the like.

A relations module 448 may be responsible to track, manage, suggest, and otherwise perform collection, analysis, creation, maintenance, communications, or other facilitation of relations between particular entities. Similarly, a persons module 449 may be responsible to manage, track, represent, facilitate, or otherwise service individual persons. In certain embodiments, a person module 449 may handle information for all persons. Meanwhile, persons may then be affiliated or otherwise linked such as through a mapping table or association table to a persistent entity, transient entity, relation, combination thereof, or the like. In certain embodiments, it is preferable to have all persons in a contacts or persons database. After all, business is operated by people, and the computers 10 involved are tools through which the persons operate. Thus, computers 10 contain data, processes, programming, instructions, and executables and data generally. However, individual persons are those who actually care about such information, processing, and outputs.

A data module 450 may include data alone, or data with a database engine, such as a query engine, database management engine, and so forth. Thus, the data module 450 may include executables and data, or may have the executables accumulating, managing, serving up, and otherwise responding to queries, or even creating queries, as independent software modules. Regardless, the data module 450 may operate on persistent data 451, transient data 452, and aggregate data 453. For example, the database 150 may typically contain aggregate data 453 relating to the inherited data that originates in persistent data 451 related to persistent entities, as well as the transient data 452 associated with transitory events. Thus, by maintaining the persistent data 451 readily available, and thoroughly linked, indexed, and accessible, and aggregated data set 453 may quickly link transient data 452 to persistent data 451, thereby inheriting comparatively instantly the attributes, and other data of that persistent data in those persistent entities.

One way this may work is, for example, an inheritance module, operating when certain fields are filled in on a template. An inheritance module 134 may track the data input, such as the identification of a venue 82. Once a venue 82 is identified, there is no need for an intervenor 101, nor the harvester 80, 100 to input any other information. Once the venue 82 can be positively identified, either by name, geographic location, address, or the like, all persistent data about that venue 82 may be drawn from the persistent data 451. Thus, a template 383 may automatically filled in by an inheritance module that immediately inherits into an aggregated record 453, or a transient record 452, of the inherited data from the persistent data 451 corresponding to the persistent entity 446.

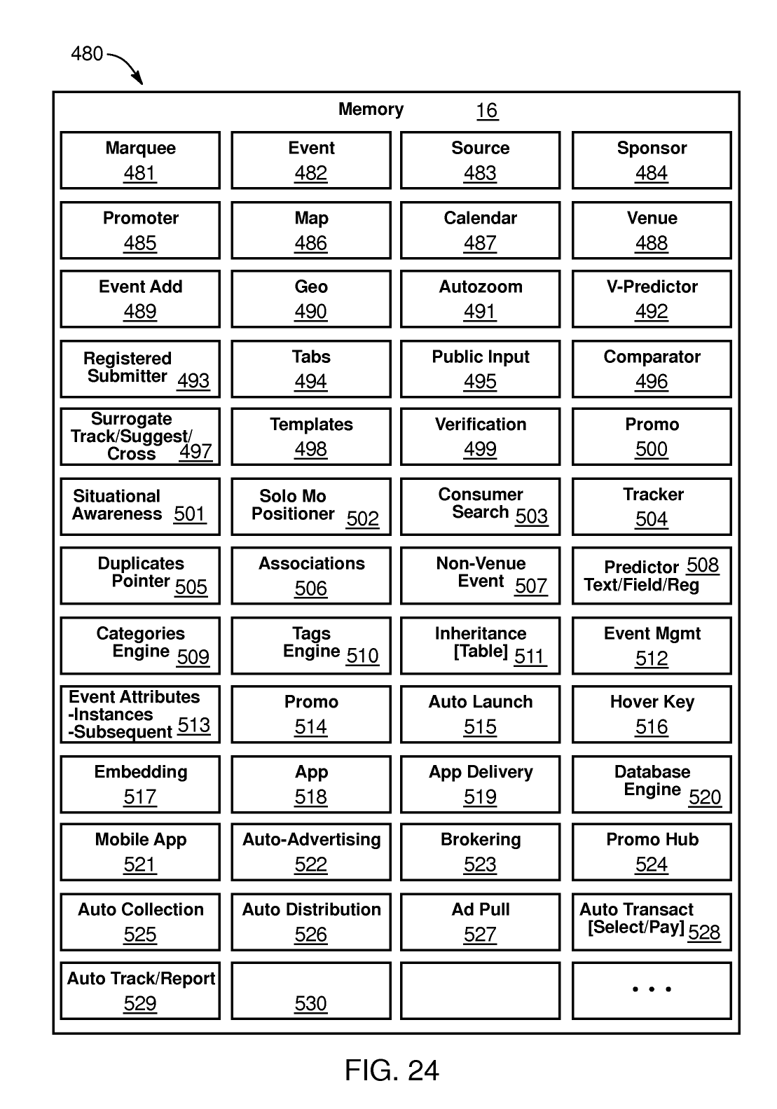

Referring to FIG. 24, an apparatus and method in accordance with the invention may include a set 480 of modules, representing both executables and data. That is, the set 480 of FIG. 24 represents both a set 480 of executables responsible to collect, process, and provide information, including analysis thereof. However, this set 480 of modules also as illustrated represents the data itself collected, served up, or output by the module of the same number. Of course, the database 150 ultimately serves, from the servers 72, information for use by all the entities who may need to access it, provide it, process it, or otherwise relate to it as described hereinabove.

In the illustrated embodiment, the memory 16 of a system 10 of computers 12 implementing a system 70 and the processes described hereinabove may include on one or more processes, and in one or more memory devices 16, which may be distributed over a number or set of modules 480 cooperatively engaged with one another. For example, a marquee module 481 may manage marquees 383.

Similarly, an event module 482 and its events 97, a source module 483 the sources 182 of event data and the like. A sponsor module 484, promoter module 485, mapping module 486, calendar module 487, and venue module 488, correspond with sponsors 84, promoters 76, mapping 466 and the like, calendars 272, and venues 82, respectively. In addition, an event ad module 489 represents an available process and data for adding events to the database 150, typically by adding them to the queue of events 97, to be processed for intake by a harvester 80, 100. A geo module 490 may collect, manage, and serve up geographic data, such as geo location coordinates for any and everything that may interact with the system 70.

An auto zoom module 491 provides for automatic zooming by display functions in the system 70 as determined by the information known about a user 86 accessing information. This function 491 may also be provided to other users. However, one of the functions of an auto zoom module 491 is to provide the data that is most pertinent, as best determined by the geographic or region of interest of a user 86.

A venue predictor 492 provides prediction of a venue based any data capable of positively identifying a geographic location of an event 97 or a user 86. If an event 97 is to be incorporated by a harvester 80, 100, then a venue predictor 492 can determine by indicia of location a particular venues. Likewise, beginning the typing of a name may also trigger a venue predictor 492, based on a combination of name, location, date, event type, spelling, or any other information, as soon as such information will provide a logical choice, or a limited number of logical choices that can be displayed to a harvester 80, 100, a user 86, or both, each in their respective situations.

A registered submitter module 493 may improve reliability by rating, ranking, or otherwise authorizing certain entities, websites, or the like to submit regularly information to the database 150, harvesters 80, 100, or the like.

Meanwhile, tags 494 have been described hereinabove. Public input module 494 may receive and manage commentary, satisfaction surveys, and the like for providing public input. Similarly, the public may request certain events 97, and the like. Public requests or searches may also be used by the public input module 494 to determine the market demand based on certain requests for information.

A comparator 496 may be used to compare information provided to information requested, distances, spellings, and so forth. A value of comparison by a comparator 496 is the elimination of duplicates for events, or any other information. Information submitted to a comparator 496 may be checked, verified, or quickly redirected in order to be able to predicatively identify information.

The surrogate module 497 has been discussed in detail and may be implemented in or more embodiments of a surrogate 120 as discussed hereinabove. The surrogate may track, suggest, cross examine, and otherwise assist a harvester 80, 100. In fact, a surrogate 120, 497 may learn more and more of the job of a harvester 80, 100, being able to predict, pre-fill templates 383, 494 and so forth.

Templates 498 may be selected for virtually any and all inputs of data, for presentation of outputs of data, and the like. Templates 498 allow individuals to quickly find information without having to read an entire text presentation. For example, templates 498 may provide inputs, or input pages, with a checklist to be filled out. Similarly, blanks are easily located and identified, information may be found for multiple events 97 or other entities at the same screen location every time, and so forth. A verification module 499 may be embodied in the harvester 80, 100, the manager 94, both, or the like. Promotional module 500 may attend to the activities discussed hereinabove with respect to promoters 76, 96 corresponding to an event 97.

Likewise, a situational awareness module 501 as described hereinabove with respect to the event forecaster 199, the situational awareness engine 152, or the like. Likewise, the analysis module 139 as part of the event engine 140 may also provide some of these functions and services. A SOLOMO position 502 may be thought of as a social, local, mobile, analysis engine and output data to permit commerce systems 90, 110 to position advertising such that it is socially transmitted over social websites, is local to an event 97, and is available on a mobile platform 86 to consumers. A consumer search engine 503 may be available in many of the embodiments of apparatus and method described hereinabove. Meanwhile, trackers 504 have been described in considerable detail.

A duplicate pointer 505 indicates analysis engine, and its data, or either individually. Indicia of duplication and entries in the database 150 may come from comparison of geo location coordinates of a venue 82, 102 used in multiple events at a time apparently the same. Likewise, spelling, misspelling, or slightly changed names, and the like may be detected by a duplicates pointer level 5 in order to quickly resolve duplicate information, duplicate entries for events 97, and the like in the database 150. Thus, duplicates pointer 505 may typically assist the surrogate 120, 497, as well as the harvester 80, 100, and manager 94 from the system 70.

The associations module 506 may make links in associations as described hereinabove, in order to fill association tables and the like. Meanwhile, linking, connecting, and the like may be done with various association modules 506. Similarly, non-venue event module 507 is directed at events 97, that do not occur in a venue-specific way. A predictor 508 may predict text, fields, records, by filling out any particular completion of text, field entry, or entire record. A predictor 508 has been described hereinabove, and various versions of same may be implemented in the system 70.

A categories engine 509 may process categories for events 97, and may manage the categories group. Meanwhile, a tags engine 570 may do the same for other characteristics by which an event 97 may be characterized. An inheritance module 511 may create inheritance tables, or may simply fill out fields, records, or the like based on inherited data, typically from persistent databases 202 or persistent records 202 that will be combined with other transitory information in the database 150.

An event management tool 512 may be of any size, and may be available to a promoter 76 in order to manage information about an event. Likewise, event management tools 512 may be used by the harvester 80, 100, manager 74, 94, or all of the above who may have access to and the right to control event information.

Event attributes may involve instances of an event, single events, and subsequent events that are patterned after, or are continuations. For example, in one embodiment of an apparatus and method in accordance with the invention, subsequent events are still treated as separate events, and every unique day for an event is treated globally as a unique event. This provides clarity, and prevents errors that come with the use of ranges. For example, date ranges for events are often an error. There may be weekends that are actually not included, there may be days that are not included, and thus an event that supposedly runs over a range of dates, or through a particular date is not necessarily open everyday during that range period. Accordingly, by providing globally unique identifiers for events, for each day, the difference between an initial event, and any other instance, such as a subsequent instant, may be managed by event attributes module 513. Similarly, the collection of attributes, and which attributes will be collected, and what level of detail, and what formats, may also be managed by the attributes module 513, and the data 513 thereof.

A promotion module 514 may provide tools, management, and the like for promotional activities. Typically, the promo module 514 applies to the promotional display of events, such as through upgrades in advertising, upgrades in entries in event database 150, and addition of premiere presentations, such as the marquees 383, and the like may be involved here. Meanwhile, an auto launcher 515 may be used for automatically launching individual entries, pages, images, or background information upon a user allowing a cursor to dwell for some period of time over a particular piece of information, and its active area. A hover key 516 may handle the timing, duration, and execution of auto launch 515 based upon tracking of cursor information by user. This may also be used in the management, promotion, harvesting, and the like procedures.

An embedding module 517 may provide for embedding calendars 272, applications, submission applications, commercial interest applications, or any other applications in accordance with the invention. In one embodiment, an embedding module 517 may allow embedding of event information, calendar information, or the like into other applications, websites, or the like. An app module 518 may provide for installation, execution, or both of an application implementing any particular aspect of a system 70 in accordance with the invention. For example, applications may be downloaded by consumers or the public users 86, by promoters 76, by commercial entities 90, 110, by venues 82, and the like. Meanwhile, an app delivery module 519 may be responsible for delivering and installing applications.

Application delivery 519 may actually occur the web, with the application actually operating on a server 72, and information and inputs being transmitted from and to the server 72 as a remote operator. This may provide for minimum instructions, and access through a browser rather than a specific application downloaded to a portable device. A database engine 520 may involve the intake, management, storage, and serving up of information in any data. For example, the database 150, may be considered the data 150, or the entire database 150, 520 including the executable drivers for collecting, managing, and serving available data.

In mobile app 521 may be downloaded to mobile devices, thus relegating the application 518 to larger systems, or served systems. An auto advertising module 522 may be used by a commercial entity 90, 110 to automatically replace advertising according to event information, rather than according to a specific number of clicks, any specific number of times, or the like. Auto advertising 522 may be implemented with much additional information as described hereinabove.

Brokering 523 is discussed hereinabove for the situational awareness engine 152, or simply for the data in the database 150 for use by commercial entities 90, 110 may be conducted by the broker 92 or system 92. This has been discussed in substantial detail, as has much of the promotional activity. Nevertheless, a promo hub 524 or promotional hub 524 may be directed toward promotion of an event 97, promotion of advertising upgrades and resources for use by a promoter 76, 96, with respect to a particular event 97, both, or the like.

Automatic collection 525 may be conducted by the surrogate 525, to be presented to the harvester 80, 100, or may be conducted by the harvester 80, 100, as learned from the surrogate 120. Likewise, automatic distribution 526 or auto distribution modules and information may be directed to consumers, with respect to an event, to promoters 76 with respect to activity associated with an event 97 they have posted, the activity and a website of a partner 78, 90, or the like. Automatic distribution of information may be sent to the public 86 desiring to know about upcoming events, or requesting watches for particular types of events, and so forth. Automatic distribution module 526 may provide for the operation of such functionality, as well as the data, the requests, the flags, and so forth in order that information is transmitted timely, completely, accurately, and specifically to the requesters, from the system 70 as collected and vetted by system 70 through the harvesters 80, 100, and manager 74, 94.

An advertising pole module 527 may permit and enable, or even collect and distribute advertising pole requests from users. For example, in certain embodiments, a public device 86 may be programmed to use the ad pole module 517 to select advertisements, subjects, tags, categories, or the like for tracking, delivery, searching, or the like. Similarly, an ad pole module 527 may be as specific as a particular user 86 desires it to be. For example, user may ask to track a particular band, and ask to receive advertisements regarding that band. The user 86 may specify to attend an event 97, and to be provided information regarding sellers of goods, sellers of musical recordings, sellers of umbrellas, or sellers of items that the user 86 will expect to want for or following the particular event 97.

An auto transact module 528 may provide for selecting and paying for items found by use of the system 70. For example, tickets, may be provided by promoters 76, 96. The auto transact module 528 may provide for pass through to the site of a promoter 76 96, or may simply provide a ticket selection and payment scheme directly and complete the transaction immediately on the site of the system 92. However, as a practical matter, ticketing may typically be done by the promoter 76, since a link to the website of a promoter 76, an event 97, or both is provided by the system 70. That is, a user may always check with the original source, which is not replaced by the system 70 within the database 150. Rather, the database 150, maintains the link assuring that a user may always get to an original source of information.

Finally, automatic tracking and reporting by a module 529 of information in, out, accesses, and so forth may be part of the analytics of the system 70 in accordance with the invention.

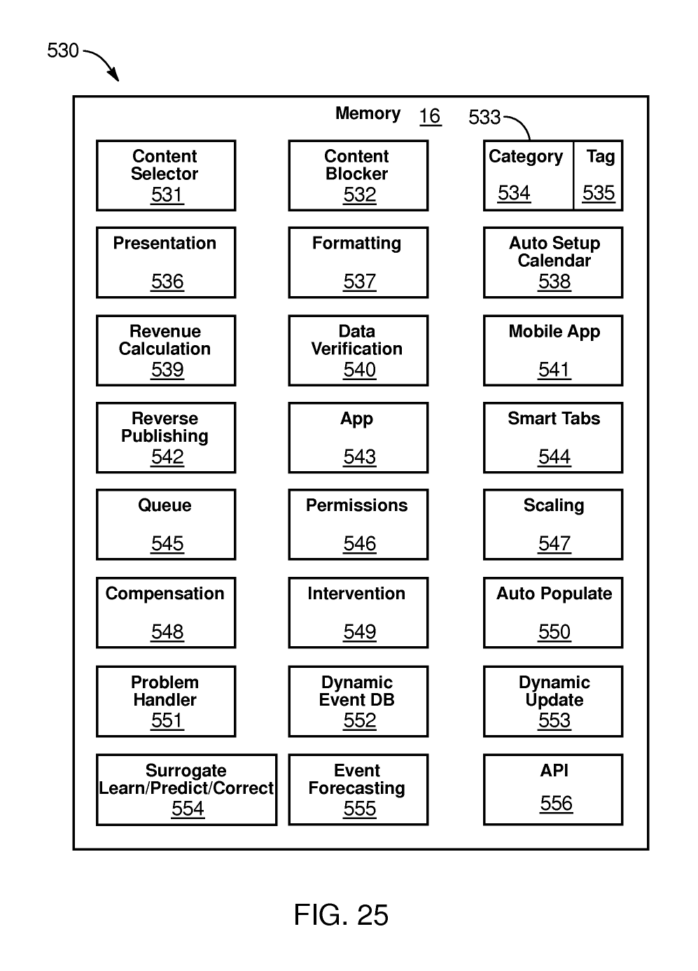

Referring to FIG. 25, a memory device 16 in one or more computers 10 in a system 11 implementing a system 70 in accordance with the invention may include certain back end functions. That is, the set for (inaudible) of modules may be thought of as serving the front end of the of the public. However, the public may include promoters 76, 96, commercial entities 90, 100, venues 82, 102, and the like, including individuals 86, 106, the back end work done primarily by the harvesters 80, 100, managers 74, 94, and surrogate 120, 497 requires its own, limited access, executables. As used herein, throughout this entire specification, the term executable means one or more computer executable instructions, such as a program, an application, a machine instruction, a high-level instruction, or the like that is capable of loading, and executing on a processor. A processor is a central processing unit identified as a physical electronic device capable of fetching, decoding, and executing a machine instruction. An executable may be thought of as any instruction, regardless of language level, from a machine level up to a high level programming, but nevertheless capable of instructing a processor to execute an instruction. An instruction may be a single instruction, or millions of lines of instruction, and still be an executable within this meaning. Not as common executable may be thought of as a set of instructions for executing a logical process in a processor.

A queue system 530 may include a variety of modules. For example, a content selector 531 may be representative in FIG. 25 as the executable responsible for content selection, as well as the data. FIG. 25 may be thought of, just as FIG. 24, as two figures. In one instance, each figure represents data where collected, processed, or served. Meanwhile, each figure also represents a representative schematically of executables responsible to collect, process, serve, or otherwise handle the data of the same name.

A content selection module 531 may be responsible to determine what content will be delivered to a calendar 272. This will typically be done in association with a content blocker 532 that determines what codes of information will not be allowed to appear on a calendar 272. This may be subject-matter based, content based, audience-sensitivities based, or the like. Typically, a categories module 534 and a tag module 535 may be included in a characterization module 533. The characterization module 533 may provide a full characterization available for classifying by category 534, as well as characterizing by characteristics, descriptions, or the like in tags 535 that will give insight into the nature of a particular event.

A presentation module 536 may present information for review by a harvester 80, 100, a manager 74, 94, or the like. A formatting module 537 may provide for formatting, such as putting information into particular styles, spellings, fonts, templates, and the like.

An auto set-up calendar module 538 may provide for interactions to make selections for what features, formats, appearance, borders, covers, and the like may be incorporated into a calendar. Functionality, clicks, hot links, zooming, and the like in order to make a calendar useful may also be included in the module 538. A revenue module 539 may be responsible for calculating revenues. Revenues may be calculated in various versions of calculators 539 related to situational awareness information passed to commercial entities 90, 100, revenue sharing for ticket sales, between promoters 76, 96, and the sellers 108 thereof, or the like. Similarly, with additional integration, or more integration, may come more interdependence between the entities involved and the system 70. Thus, where money is collected and to where it is directed may be established completely by contract on any arbitrary scheme, based on the agreements of parties. Thus, a revenue calculation module 539 may be effective to provide for collection and distribution of revenues in order to simplify the procedures required of a consumer 86 purchasing a ticket for attendance at an event.

Functionality of the data verification module 540 may be incorporated into the harvester 80, 100, the manager 74, 94, or both. A mobile app module 541 in the context of the queue of events 97 being input to the database 150 may provide functionality of the harvester 80, 100, the manager 74, 94, or both on a mobile platform. Thus, an individual may still input event information form a cell phone, smartphone, tablet, pad, or other electronically operable, network-aware device that receives inputs.

A reverse publishing module 542 may provide for publishing information input into the database 150. Typically, information will be published in a calendar 272. In addition, individuals may choose to publish information for events with which they are affiliated, directly. An app module 543 may provide for an application that may be installed in any computer that is not dedicated to the use of the harvester 80, 100, manager 74, 94, or both. Likewise, an application module 543 may provide an application, may run an application, or may download an application to individuals who may choose to represent or operate the partner modules 78, 98, the venues 82, 102, and the contributors 105, commercial enterprises 90, 110, or the like. Thus, the functionality may be provided over a browser, or by a direct application 543 downloaded, or hosted remotely on another computer.

Smart tags 544 or a smart tags module 544 may be responsible to provide additional detail information in addition to a simple word or description for a tag. A tag may be thought of a property, characteristic, or other type of information associated with an event. For example, some events may involve alcohol, some events may involve children, some events may involve education, some events may involve sports, some events may involve any number of other characterizations. However, the smart tags module 544 may provide for the rapid and intelligent inclusion of tags, to characterize events 97, based on information available when the event 97 is harvested or its information is harvested for inclusion of the database 150.

A queue 545 or queue module 545 may be thought of as a management executable 545, and the data therefor 545 may be thought of as the incoming inventory, so to speak, of events 97 that are being processed. Accordingly, the functionality described hereinabove may be included in the queue 545. Meanwhile, accommodating permissions module 546 may distribute authorization, access, and control same on behalf of any of the parties discussed with respect to FIGS. 1-25. For example, the database 150 cannot be opened to everyone. Nevertheless, event information is available to individuals, particularly through calendars 272 served up by partners 78, 98, and the like. Nevertheless, the system 70 may include presentations of calendars 272 directly by the event engine 140, or the broker/system 92 within the system 70. Accordingly, activities are permitted by what players may be controlled, with the corresponding data stored in order to provide rapid access and security simultaneously.

A scaling module 547 may be responsible to provide additional expansion of functionality of calendars 272, the system 70, or the like. In other embodiments, a scaling module 547 may provide for distribution of information, and literal presentation.

A compensation module 548 may relate typically to harvesters 80, 100 who are compensated for gathering and verifying the accuracy of event information. In certain embodiments, the harvester 80, 100 may be compensated according to which types of events 97 are harvested, the accuracy, the speed, the lack of errors, the comprehensiveness, and so forth. With the analytics available, compensation may be thereby tied to performance, and value to the system and to users.

An intervention module 549 may provide the intervention functionality by presenting information to an intervenor 101 and receiving inputs in order to provide for human intervention in verification processes of the harvester 80, 100, and the manager 74, 94.

An auto population module 550 may provide for auto population of fields, templates, records, and the like. This will typically be in conjunction with the surrogate 120, or with information provided from the surrogate 120 and thus embedded or incorporated within the harvester 80, 100 to benefit from institutionalized knowledge. For example, a venue 82, 102, once clearly identified, by sufficient information to indicate that the venue 82, 102 is the same as one already in the database 150, may result in an immediate inheritance and downloading to an event record 271 all of the corresponding venue information. This saves time, improves accuracy, prevents duplicates, and so forth Likewise, auto population 550 may do the same for any field, any record, or the like in any template.

A problem handler module 551 may identify, track, suggest, and otherwise handle problems that exist in records 271 that are under construction. That is, a record 271 does not go into the database 150, until it has been verified for accuracy, lack of duplication, and so forth. The problem handler 551 manages these procedures, and may be implemented into the manager 74, 94, or may stand alone. Likewise, a problem handler 551 may also have a portion, or an entire instantiation within the harvester 80, 100, instead, or in addition.

The dynamic event database 552 may be thought of as the database 150. That is, the module 552 may represent any or all of the functionality of the system 70 required to create a dynamic event database, maintain it, and so forth. Meanwhile, a dynamic module 553 may provide for interaction with the database 150 by any suitable party, so long as the proper permissions 546 are available. Thus, for example, a promoter 76, 96 may dynamically update an event, by changing a time, changing a date, changing a performer, or simply changing level of advertising. Thus adding marquee advertising 383, highlights, and the like, may all be possible dynamically.

A surrogate 554 may be thought of the surrogate 120, inasmuch as the process of learning, predicting, correcting, and otherwise processing information need not be relegated to the limitations of a program in the harvester 80, 100, nor relegated to the memory and skill of an intervenor 101 operating the harvester 80,. 100. Rather, a surrogate module 554 may be embedded as an independent module in any aspect of the system 70 where information is transferred. Tracking, analyzing, thereby learning, predicting, correcting, suggesting, and the like may all be functionality that may be embedded in any location where it may be useful.

As a practical matter, a surrogate 554 may be embodied in the surrogate 120 used to effectively train, assist, and learn from the operation of a particular harvester 80, 100. An event forecasting module 555 may originate in the function of a surrogate 120, 554. However, additional information regarding the analytics of the nature, timing, season, promoter 76, 96, and the like may indicate that certain events 97 will repeat on a monthly, daily, annual, or other basis. For example, a local rodeo that is held on a particular holiday may be forecast to occur again on that same holiday at the same location. Thus, an event forecasting module 555 may use the analytics of such information in order to forecast events, thus indicating to a harvester 80, 100 that such an event should be looked for. Similarly, such information may be provided to a surrogate 120,554 in order to go looking for such event information, which may be in a slightly changed form, or exactly the same form.

Meanwhile, application programming interfaces module 556 may be provided for downloading to application developers who choose to invent calendars 272 and applications, or otherwise access the system 70 in order to add events, download events, or otherwise interact with events 97. Typically, an application programming interface module 556 (API) would typically be used by any one or all of the entities identified in the system 70, such as those in FIGS. 2-4 in order to allow interaction with the system 70. In particular, API modules 556 may relate to embedding calendars 272 with their associated software controllers on a site of a party that desires to be a partner 78, 98. Likewise, however, any individual who is operating a harvester 80, 100 may do so through an application programming interface. Meanwhile, other embeds of (inaudible) functionality of the system 70 in accordance with the invention may be provided with their individual operating of APIs 556.

In general, a partner 78, 98 may be any particular business or entity that desires to provide an event calendar 272 as a public service, as a traffic draw for internet browsers, as an information resource, or the like. Many partners 78, 98 are media outlets 78, 98. Accordingly, their interest is different from the interest of ticket sellers. Their interest is actually different from that of various contributors or performers who may participate in an event 97.

Likewise, regardless of the technology, whether new media 364 or traditional media 362, reputation or the trust of the public is a major asset. Similarly, reader loyalty is a major asset. Revenue depends on circulation or viewers. All of the foregoing rely on the reputation for quality in both in accuracy and completeness of information presented. Moreover, credibility as a source that can be relied upon is critical. Thus, a system 70 in accordance with the invention provides these at a very competitive cost.

Meanwhile, promoters may have outlets for information, but always need outlets and the number of outlets or advertising impressions per dollar spent may be extremely important. For example, a school advertising a play does not have a large budget, compared to a rock band on tour. In any event, maintaining a maximum number of outlets for each dollar spent in advertising, maximizing the numbers of readers or eyes viewing any advertising medium, and the like matter significantly. How much exposure may be obtained in any event is a major self interest of a promoter 76, 96. Accordingly, the amount of such exposure for the revenue spent is, or can be, critical. In the system 70, any degree of exposure may be obtained at a corresponding cost. Initial entry of an event 97 in the database 150, and thus displayed on a calendar 272 is free to the promoter inasmuch as it is to the benefit of every partner 98, 98 to provide as much completeness as practical Likewise, it is to the self interest of the event engine 140 and the system 92 of the market maker/broker 92 to include all events, above some nominal threshold size. Thus, the system 70 is aligned with the interest with the promoter 76, 96, a partner 78, 98, and the market maker/broker 92, as well as any performer in an event. Thus, the classic conflict of interest between ticket sellers and media event calendars is removed by the system 70.

Thus, the system 70 provides accuracy, comprehensiveness or completeness, and ease of navigation. Meanwhile, upgrades in advertising available to promoters 76, 96 may be provided as necessary, and are not required if outside the financial reach thereof. Likewise, community curators, individual entities within a community who may be in charge of events 97, create them, noise them abroad, or the like are assisted as promoters 76, 96 within even zero budgets. Notwithstanding the division away from the interest of ticket sellers or resellers, the system 70 still serves the interest of ticket sellers, particularly in that they reap benefits of advertising, accessibility, and the general additional number of impressions provided for any event 97 presented in a calendar 272 based on the database 150.

A significant complaint by subscribers to various news media, whether radio, television, newspapers, or the like is that news too much tends to be national or regional, to the exclusion of local. The system 70 provides for local readership, local events 97, and automatically provides for navigation and mapping according to the user 86 or consumer 86. Thus, the system 70 automatically maps the relationship or location of a user 86 accessing the system 70, and presents information peculiar to that locale, of the user 86, unless directed otherwise. For example, a traveler may prefer to investigate activities distant from the location where that traveler is located at the time of the search or browse session. Thus, the system 70 automatically selects a region according to the location of a browser 86, but may be redirected explicitly by proper instructions.

In certain embodiments, a homepage for the queue or the harvesting process, may include a tab for returning to the homepage, a tab for presenting a calendar, a tab for event entries or events generally, a website tab, an accounts tab, a logout tab, and the like. It may also include menus and search term dialogue boxes.

For example, in certain embodiments, a list of venues to be checked, that have not been checked by a harvester 80, 100 may be listed Likewise, contributors (performers, others who may contribute to an event 97, and the like) may also be listed to be checked and verified by an intervenor 101 in order to be submitted by the harvester 80, 100. Control buttons may indicate lists to be viewed, assignments to be viewed, controls of disposition, and the like. Meanwhile, a list of recently added events that are in the queue awaiting action by a harvester 80, 100 may be listed by the date logged in, the date of the actual event, the title of the event, and other selected information.

In certain embodiments, the homepage may also include the indication of status or rank of a particular harvester 80, 100, and identify accuracy, number of events approved that have been submitted to the database 150, the number of events with problems, and thus being denied entry into the database 150, the number of events deleted due to the fact that they were duplicative, or obtained from improper websites, or the like. Thus, a performance parameter may be provided to provide feedback to the harvester 80, 100. Meanwhile, a performance standing, level, or other indicator may be provided.

Meanwhile, compensation and financial information may be provided, such as a base rate for an entry of each event, a rate for entry of recurring events, which are based on a base event, but which need their own verification. That is, every event is best maintained as a globally distinct unit. Thus, any particular event 97 will be restricted to a certain day. A second day of a continued event will be listed as a separate event in order to provide accuracy, completeness, and so forth. Thus, a recurring day of a same event, or other recurrence of an event may be compensated at a difference rate. Similarly, national events may be identified at another rate. For example, a national event may be, for example, a tour of a rock band, museum show, art show, touring theater group, or the like. Thus, a national event may be compensated at a different rate. Meanwhile, deleted events may be identified for the amount of compensation removed. This would typically apply to events that have passed verification, but are later found incorrect and therefore deleted. Meanwhile, problems may result in a reduction in compensation. A total compensation may be shown on the homepage of the queuing management system or the queue. As to calendar information, calendar tab may raise several topics, such as a listing of media partners, a listing of areas of coverage by calendars or event coverage, population centers, tags available, violations of record rules for recording events 97 in the database 150, contributor types, and so forth. In certain embodiments, for example area may be identified, or some period of time, and may have reports that may be generated regarding the region or area, how many pending events are in the database 150, the goal for that region in harvesting events, as well as a performance by month or other period of time for events occurring within that area.

A calendar may also apply to population centers. These will typically be metropolitan areas around large cities. It has been found effective to make the entire database 150 very tightly bound to geographical identification. Accordingly, every population center may be identified by latitude and longitude, typically for the center of the population area, city, or the like.

Tags may include a number of items that will characterize any particular event 97. For example, tags may include such items as races by type. Iron Man, triathlon, 5K, 10K, marathon, and the like may be tags applied to racing events. Similarly, tags such as 18 and over age, 21 years and older, children, no children, and the like may be used. Similarly, the presence of alcohol, the appropriateness of all ages, rock, blues, alternative rock, bluegrass, classical, country, or other types of music may be included as tags. Likewise, the presence or participation of animals, the availability of various facilities, and the like may also be used as tags.

Certain tags may be applied to blocked content that will not be permitted. In fact, blocking may be used for specific sites that are known to be unreliable, inappropriate, or the like. Meanwhile, every type of sport, whether it be baseball, basketball, football, hockey, or the like may be listed as a tag. Similarly, every type of music, racing of motorcycles, automobiles, bicycles, and the like may be listed individually to characterize events 97 by tags 431.

Certain websites may be blocked, books signings, Broadway plays, cabaret or night club events 97, charity events 97, seasonal or holiday events 97, may be identified for holidays such as Christmas, New Years, Yom Kippur, Hanukkah, Easter, or the like may be included. Similarly, church services, church auxiliaries, circuses, civic events, classes, classical (applied to anything from music to dance to art) may be used as a characterization tag 431. Contributor types may include such designators as athletes, colleges, collegiate sports associations, musicians, non profit organizations, other performers, professional sports associations, professional sports teams, sponsors, and so forth. Other contributor types may be added for characterizing contributors and events by their contributors.

An events tab may include information such as a search for contributors. For example, certain accounts may be identifiable, such as all accounts, assigned accounts, unassigned, assigned to, and the like. Accordingly, a user may select types of accounts to look at. Similarly, contributor types may provide for filters to be selected. A window may be provided for displaying information and making selections Likewise, buttons to assign or unas sign a particular contributor to an event, or the like may be provided on the page.

Various types of contributors may be listed by name, by type of entity, such as a singer, performer, dancer, institution, college, or the like. Similarly, a particular contributor may be assigned to a particular harvester 80, 100 managed by an intervenor 101. Similarly, contributor searches may also display on a suitable screen, a time or elapsed time since a particular contributor was check for additional event entries. One value of having a particular harvester 80, 100 and intervenor 101 assigned is to assure completeness, without duplication of effort, or the like. The assignment to a particular intervenor 101 may be according to expertise, experience, education, interest, location, or the like.

Violations of calendar entries may include such things as bad abbreviations, web links, sources, or formats used. Similarly, if a contributor designation is improper, or is not properly abbreviated or not used, this may be identified as a violation. If a description is too long, too short, has improper capitalization, or the like, and may result in a violation referred back to a harvester 80, 100. Incorrect admission price, incorrect categorization, incorrect tag association, incorrect title, incorrect grammar, incorrect venue, missing contributors, missing recurrence of events, a missing tag, a missing category, or even missing a particularly specific website that may be is the originator, or may be flaws in event entries.

If a venue detail should be summarized in a venue summary, and is absent, this may result in a violation, as may spelling errors, the use of a subtitle improperly, the lack of use of a subtitle, the inclusion of a venue name and a title, when it should actually be extracted and included on the venue designation, to say nothing of wrong dates, of wrong times, and the like may cause violations. Similarly, the fact that a national tour should be indicated, or a designation as a national tour event may also result in a violation of the requirements for accuracy, completeness, lack of duplication, and so forth.

A problems menu or problems window may provide as all windows a dialogue box for searching for specific items by spelling, key words, or the like. Similarly, problems may include a listing of menus and titles, long titles, long descriptions, short descriptions, bad sources, abbreviations available that are not used, and so forth. Likewise, a timeliness factor may be included by identifying whether a problem record was created today, within a few previous days, within the past week, within the past month, within the past quarter, or the like.

Entries may be provided some indicator of aging, and thus need for prompt attention. A button indicating a need for updates, may allow a user, by way of an intervenor 101 operating a harvester 80, 100 to update, without updating at every change of information. Thus, this assists the user and maintaining a stable window while edits are made to correct problems. Thus, problems may be identified by a date, event name, venue, and so forth. Sources of events may be listed in a table presented in a window to a harvester 80, 100. A website URL may be indicated for a particular source that will be continuing to be reviewed. The number of events found on that site, either on a periodic basis, or on a totality basis may be indicated. Similarly, the number of views that a calendar 272 has seen may be indicated. Similarly, the number of views by the website, that it is reviewed within some period of time or since beginning, may be indicated in a column of numbers.

Also, sources may be characterized in a table that also lists the latest event that is being advertised or that is found, or the last time the latest event was downloaded therefrom. Similarly, a priority in terms of the experience of utility of a particular website may be indicated as high, medium, low, or some other numerical ranking instead. The last update for the URL may be identified. Accordingly, there is no point in continuing to visit a website that does not update its information. Thus, if a website has not been updated in a month, there is no need for the system 70 or a harvester 80, 100 to go back and once again service that site, since no information has been added. Meanwhile, other notes that may be of utility to the harvester 80, 100, the intervenor 101, or others, such as the managers 74, 94 may also be included in the notes field.

In one embodiment, a venue search may obtain by clicking a button or tab associated with an events tab in the queue webpage. For example, a listing of accounts, with a selection thereof, including all, assigned, unassigned, those assigned to a particular individual who may be selected in a dialogue box, or the like may be included. Similarly, the tier may be indicated, in any ranking, such as all, tier 1, tier 2, tier 3, or the like. Thus, a first tier venue may be designated by size, quality, other objective or subjective criteria, or the like. Typically, capacity will be factored into the tier designation of a particular venue. Likewise, data that will be missing or is to be edited out may be included by including a filter, adding no filter, providing a website address, going to the website, providing a street address, or the like. Similarly, an update button may designate when inputs may be updated or should be updated.

Typically, a particular harvester 80, by way of an intervenor 101, may indicate identifying information. Buttons may assign or unassign particular events from a table may be accessed. Likewise, buttons requiring the designation as tier 1, tier 2, or tier 3 may be included. Thus, for every event, a name, city, tier, assignment name (assigned intervenor 101), a status designation as to whether verification is being completed by the harvester 80, 100, the manager 74, 94, or both may also be included.

Events may display a window having a calendar along with tables of pending events publically submitted, pending events that have been submitted by the queue through the harvester 80, 100, the surrogate 120, or the like. Thus, the date submitted, the time submitted, such as a time stamp, the event date and time, and event title, a venue, and the like may be provided for each event in the table. The table may include as well pending repeating events. In fact, it may be an error if repeating or subsequent events are found to be available, and the harvester 80, 100 has been required to identify repeating events, and has not.

A partner may provide a page or window on a website including calendars, brief descriptions, images, video, pictures, or the like for various items. For example, a news-related medium 364 may include, for example, a market place of products and services, events, deals, coupons, news, classified advertisements, obituaries, automobile advertisements, real estate advertisements, local community events, entertainment, or the like. Accordingly, a calendar may be presented to a user 86. Meanwhile, selection of a date, event, or the like, the presentation may be changed to provide a particular event, a particular date, or a particular listing of events on a particular date, at a particular time, or the like.

Typically, a date calendar may fill substantially an entire window, but may be shrunk to become only a reference calendar, or in certain events, dates, or the like are selected for further perusal. Thus, the date designated for which information is being displayed may be highlighted on the calendar showing all the dates of the month or nearby. Meanwhile, an area, such as a city designation or metropolitan area designation, as well as various categories of events may be listed.

For example, categories may include all, comedy, movies, concerts, dance, plays, outdoors, theaters, charity events, and so forth. Accordingly, a user 86 may designate a particular category or multiple categories and have a listing of events, including key information such as title, venue, pictures, clips, address, time, admission price, and the like. Meanwhile, a player may play video materials, such as video clips by selection and launching by user 86.

Maps to events, or directions may also be provided. Meanwhile, searching may be available by key word, or any other word. Typically, the marquees 383 will be listed immediately above the calendar providing an opportunity for promoters 36, 96 to obtain additional impressions, and of a higher quality. Meanwhile, buttons may exist for looking at partners, adding events, logging in, finding out about a calendar or a partner 78, 98, or the like. Similarly, information regarding sponsors, access to calendars to power additional sites, and the like may be included. In one presently contemplated embodiment, buttons are available to designate or select information and communications in order to promote an event.

For example, an individual, regardless of status who is looking at a calendar 271, may determine a desire to promote an event. By clicking on that button, the opportunity to add an event may be presented. A dialogue screen may provide for sponsor information, venue, name, nearest metropolitan area for geographic location purposes, and standard information such as date, time, name, organizer or promoter 76, 96, additional details that should be included in any associated text, special requests in the display of the information, and the like. Contacts, email addresses, extra advertising features, such as highlighting, including a marquee 383, or the like may be provided. Likewise, providing a logo corresponding to an event 97, a promoter 76, 96, the particular performer 84, or the like may also be included and uploaded on the screen. Meanwhile, the conventional administrative information may be provided such as terms of use, privacy policy, contacting the partner responsible for the calendar 272, contacting the entity operating the system 70, or the like may also be included. In certain embodiments, the homepage may provide for a user to create a calendar by providing details in a dialogue box that asks for URL, subdomain, title, calendar URL, and the like. Similarly, selections may be made for style, theme, logos, and the like. The events selected to be in the created calendar, or included may be characterized by categories, tags, both to be included, and blocked, as well as zip code of the partner 78, 98 hosting the calendar, and a geographical region to be included, such as a radius. Meanwhile, in a promotions directed to particular audiences selected, may be identified. Meanwhile, data such as the number of site visits per month may be recorded, but also may be submitted for the website seeking to host a calendar 272.

The audience to which a particular site is directed may also be identified in terms of location, demographics, age groups and other information. Premiere benefits that are purchased or offered may also be designated. Event information may be edited with an editing page that permits text, images, video, and the like. Accordingly, once changes have been input, edited, and the like or simply cut and pasted, then buttons may indicate to make changes, add extra features, add to the shopping cart of a particular partner 78, 98 desiring to host a calendar, and so forth. Designations for marquees, cost of promotion, transactional windows, and the like may provide for online transactions for any number of listings. Thus, event information may be added by a promoter 76, 96, and may pay for additional promotion beyond the bare submission.

In certain embodiments, a properly authorized person operating through the harvester 80, 100, the manager 74, 94, or the like may change an event. For example, the time, venue, admission price, even the performer, or the like may be changed. Similarly, categories, tags, and the like may be edited. Contacts may be changed, added, corrected, and so forth. Details of the event, may include an event history. For example, if an event has been repeated, then the dates of previous related events, persons, activities, actions, and the like may be included. In certain embodiments, tabs at the top of a homepage, for example, may provide for navigating to the homepage or back to the homepage, identifying a particular partner 78, 98 hosting a calendar, and therefore returning to the homepage of that partner 78, 98, a request to add an event, to create another calendar, to go to the events themselves, or the like may be included. Likewise, buttons for partners, adding events, learning about the calendar, the event, the partner, the system 70, or the like, as well as login by those authorized may be provided. Maps may be included to provide conventional maps, as well as video viewing, such as Google Earth, and the like. These links may be embedded directly within the pages to accompany calendar events accessible by users 86.

Thus, in certain embodiments, an apparatus and method in accordance with the invention may provide location awareness and situational awareness for use by marketing entities. Network-available data, plus real world intelligence regarding a situation as reflected in events and attendees may be provided to commercial enterprises. Accordingly, they may direct the attention of advertising media to those markets. Rapidly changing, time-dependent data is very high cost, and low value.

However, by tying such transitory to non transitory elements that have a relationship, and finding a rapid way to inherit attributes from finite and persistent data into the world of infinite and transitory data provides a dynamic database with a dynamic inheritance in order to speed access, minimize effort, and make more cost effective the output. Thus, inheritance of persistent data by non persistent events provides increased value, relevance, timeliness, with pinpoint accuracy, dynamic targeting, and access to pull marketing by social, local, mobile platforms 86 of individual users. Because every event has a unique URL there is an increase in the search engine optimization effectiveness.

A system 70 may be executed as a stand alone software application, as a mobile application for a PDA, as a plug-in to a browser, or simply as a software layer that effectively “lives above” a browser. A system may cut text to paste it in order to harvest data, populate fields and records, and automatically fill information that is already known, such as all the details about a venue. Event logos, rich media, such as video and the like that are available may be intelligently selected by humans in response to requests of promoters 76, 96provision of such materials by a promoter 76, 96, or simply by virtue of their being present on a website of a promoter 76, 96 that is searched for such event information. Effectively, an event trailer may be included for an event. Moreover, links, or downloads from performers may be added to an event record. And may be displayed with the event on a calendar 272.

A system in accordance with the invention provides dynamic searching and downloading, a database structure, query optimization, a new promotional technique or system, managing of scale, a widget builder that may be downloaded or used to build a micro application, a dashboard for operation by harvester 80, 100 and easily learned and operated by an intervenor 101 in the person of a specialist or operator. Problems and deletions, recurring events, venues, contributors, event coverage are all handled readily. One-click financial management is available, particularly one-click payroll, saturation of a metropolitan area or venue is possible by filling up the space in time and geography. Once a venues dates and spaces have been filled, saturation is achieved.

Events as disparate as outdoor hunting seasons and Broadway productions may be listed as events. School plays, commercial activities, and the like may all be included. For example, contributors are the game, the departments of natural resources of states, and so forth. A season is an event. Everyday may be a globally identifiable event. The geographical boundaries of a hunting jurisdiction is the geographic boundary of the venue. Meanwhile, an arena hosting an athletic event provides the same. Situational awareness and situational awareness marketing are enabled thereby.

A smart surrogate may operate as the tool to collect information, make suggestions, cross exam decisions of a human, provide checklists, and even provide initial harvesting. Nevertheless, all information can be human-verified. However this verification can happen at an extremely high rate of speed, as much as a surrogate, and the other modules corresponding to a harvester 80, 100, and a manager 74, 94 continue to learn and do more of the work automatically, thus presenting information to local people who know what they are seeing, and thus make intelligent decisions. This surrogate may call human attention to sources, may monitor how humans sort and filter information, may offer corrections, and so forth. Thus, a surrogate appears like a human being in a robot suit. By providing one hundred percent human-verified content, reliability is superior to all web crawler technologies.

Moreover, the system 70 not only gathers data, but gathers information around that data that may provide context or additional “intelligence” for analyzing the data and characterizing it. Accessed by viewers, to tickets, tweets, and their like may be used to substantial benefit. Thus, the system 70 results in a very social, but not intrusive, distribution of information. The system can do a location by event, search by schedule, event type, may do event forecast, may do target marketing related to an event, and the like. Thus, marketing intelligence is greatly increased. Moreover, the time on this, and the cost effectiveness of addressing smaller markets more rapidly become available.

The connection between web information, analytics, and brick-and-mortar businesses are finally linked at a timely fashion and directed to marketing to “pull” of customers who request information, search for, or authorize delivery of it. A media organization 362, 364 may improve their reputation, improve their timeliness, their accuracy, completeness, comprehensiveness, and the like without substantial cost to host a calendar 272. Moreover, the calendar 272 may be tailored to block content that is inappropriate by age or any other particular criteria, characterizing events, and yet may be tailored to include all events that will be appropriate, desirable, and the like. Thus, comprehensiveness without offensiveness is possible for improving the reputation for customer-awareness and satisfaction by any partner 78, 98, and particularly media partners 362, 364.

Categories may be limited in order to make navigation easier, while tags may be of any number, and characterize as specifically as desired. New tags can be added, and applied, and may applied automatically by the surrogate 120, as well as by the harvesters 80, 100. The idea that tags need not be exclusive from one another, nor exclusive with respect to categories greatly improves the ability to target information to be included or blocked from a calendar 272.

Thus, a system 70 in accordance with the invention may approach events 97 by focusing on constants, and have those constants available, to be added to the transitory information. Thus, prior art, such as crawlers, and the like have not considered what factors should be properly identified, in order to characterize for inclusion, blocking, and selection, events 97 for inclusion in a calendar 272. Events, by their very definition are transitory. Entities, websites, venues, physical brick-and-mortar and the like are not. The unsolved problem of the “unwieldy” and extremely non-economical ability to deliver events, and event calendars extensively, ubiquitously, and comprehensively, while still maintaining accuracy, consistency, completeness, and reliability has not been provided by any other solution known to the inventors.

The safety of auto selection based on categories and tags selected by a partner 78, 98 hosting a calendar 272 cannot be over emphasized. At a global level, blocking is by tag. Likewise, at a global level, every venue, every event at that venue, everyday is a unique global identified global event 97 that is separately addressable, identifiable, modifiable, and the like. By identifying the constants that may be moved from event to event, the system 70 has provided a situational awareness for events. Thus, far beyond the three dimensional mapping of an area, with identification of significant obstacles, blockages, and the like that will influence movement of a tactical military group, a situational awareness engine 152 in accordance with the invention will provide dynamic situational awareness for marketing entities, which will be geo-located, timely, and tied to the events, attendees, mental states, and the like of a specific, targeted, and comparatively smaller but now accessible market.

Speed is achieved by the use of association tables. A process of checking sources, checking for duplicates, receiving smart suggestions, suggested tags, suggested categories, and the like, as well as a quick venue entry by automated systems, and tracking the constants of events and inheriting their characteristics into dynamic events provides speed, accuracy, and information far beyond that available even to the promoter 76, 96 responsible for putting on an event. All this time, a surrogate 120 can begin to do what a human could only do before. The surrogate may track and analyze the human activities, and thus do more of the job for a human, and leave for the human being 101 to decide decisions that can only be processed by that logic. That logic, and recognition capacity, of the human brain is a processor.

The team of intervenors 101 operating the harvester 80, 100 may be completely disparate, highly independent, widely dispersed, self motivated, and yet still work cohesively as a distributed collection system. Each intervenor 101 is local to events, interested in a genre, educated in particular events, and dedicated to harvesting particular sites and finding others similar. Thus, a ranking may provide a beginner, apprentice, expert, master, or other designation that will effect directly the rate of pay for events added. Accuracy may also be factored. Thus, an intervenor 101 may be paid for the number of events, accuracy, and the ranking, as a result of historical performance. Thus, loyalty of team members has improved, by compensation as well as areas of interest.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus operating as a situational awareness engine, the apparatus comprising:
a medium, comprising a non-transitory, computer readable storage medium storing modules executable on a processor;
a processor system, comprising at least one processor operably connected to the medium and executing the modules; and
the modules, comprising
a partner module accessing a host module creating and hosting a database corresponding to an event calendar, served from a server module, by selecting and processing data characterizing persistent data corresponding to a venue, and transitory data characterizing attendees corresponding to an event reflected in the event calendar,
an integration module determining a correspondence between, and combining in accordance therewith, persistent data characterizing comparatively permanent entities and transitory data characterizing at least one of attendees, performers, promoters, sponsors, and a combination thereof, with respect to an event
a calendar module programmed to determine, based on arbitrary criteria, other events with which to group the event in an event calendar,
a situation analysis module evaluating and determining who, by at least one of type, number, and another parameter associated with and characterizing people as attendees, is at the event selected from the event calendar, and
the situation analysis module, further programmed to determine at least two facts selected from where persons will be, near an event venue, why, an explicit description of state of mind thereof, and an implicit state of mind thereof.

2. The apparatus of claim 1, wherein the modules further comprise a fact module, programmed to process information, obtained from the database and event engine, to assess key facts of a situation corresponding to the persons, the event venue, and the time selected.

3. The apparatus of claim 1, wherein the modules further comprise an inference engine interacting with the situation analysis module to select inference facts and completing at least one of drawing inferences, determining conclusions, and calculating comparisons therebetween.

4. The apparatus of claim 3, wherein the modules further comprise;
a communication module selecting, according to user criteria, information to be provided as output from the situation analysis module back to the commercial module; and
at least one other module providing an analysis selected according to criteria characterizing an interest corresponding to information processed by a commercial module.

5. The apparatus of claim 4, wherein the at least one other module includes:
a dynamic targeting module controlled by information characterizing criteria received from the commercial module; and
a verification module selecting for communicating to outside the apparatus a specific type of information.

6. The apparatus of claim 5, wherein the situation analysis module and the dynamic targeting module operate as separate units.

7. The apparatus of claim 5, wherein the dynamic targeting module provides the functionality by logical execution of analysis steps to determine the significance of facts, received from the situation analysis module, based on criteria reflecting advertising priorities determined by the commercial module.

8. The apparatus of claim 7, wherein the commercial module is further programmed to:
determine entity information, based on commercial criteria corresponding to a commercial entity controlling a commercial enterprise;
manage the entity information; and
serve the entity information regarding the commercial enterprise.

9. The apparatus of claim 8, wherein the commercial module is embodied within a system executing executable instructions hosted on at least one of a commercial computer and an independent commercial enterprise software module.

10. The apparatus of claim 9, wherein the commercial module is programmed to:
select a list of at least one of products and services;
determine and serve a description thereof; and
determine and serve images corresponding thereto.

11. The apparatus of claim 10, wherein the images comprise a video presentation.

12. The apparatus of claim 11, further comprising:
an advertising criteria module determining advertising criteria associated with products comprising at least one of a line of goods and a line of services, the advertising criteria reflecting a relationship between the products and the attendees at the event.

13. The apparatus of claim 12, wherein the advertising criteria reflect at least one of attendee-specific demographic, need, and attitude corresponding to the event.

14. The apparatus of claim 13, wherein the analysis module is further programmed to dynamically target for the commercial module particular targeting information selected by the commercial module, based on the event and advertising criteria corresponding thereto.

15. The apparatus of claim 13, wherein a products and services module is programmed to serve data corresponding to at least one of food, drink, and memorabilia based on advertising criteria corresponding to the event.

16. The apparatus of claim 1, wherein the commercial module includes a targeting suite comprising software determining a targeted demographic based on criteria reflecting a commercial analysis, marketing information, decision processes corresponding to the commercial enterprise.

17. The apparatus of claim 16, wherein the commercial module includes an advertising criteria module programmed to receive and process data to determine advertising criteria by which to coordinate products with the event.

18. The apparatus of claim 17, further comprising:
determining by a targeting module the advertising criteria, based on selecting from all products corresponding to the commercial entity and the attendees;
determining, by the processor system, a link over which to send a recommendation to an attendee, the link being selected from a mobile phone, an email device, another messaging device, a tablet, and a computer, wherein the link is determined from the persistent data corresponding to an attendee and the transitory data corresponding to a performer at the event.

19. A method of executing a demographic predictor system communicating over social media platforms demographic predictions characterizing a population of attendees at an event, the method comprising:
providing a medium, comprising a non-transitory, computer readable storage medium storing modules executable on a processor;
providing a processor system, comprising at least one processor operably connected to the medium and executing the modules;
executing on the processor systems a plurality of modules to effect decisions;
accessing, by a partner module a host module;
creating by the partner module a database;
managing, by the partner module, an event calendar by selecting and processing data characterizing persistent data corresponding to a venue, and transitory data characterizing time, performers, and attendees corresponding to an event reflected in the event calendar;
serving, by a server module the event calendar;
determining, by a market maker module, a combination of the persistent data and transitory data characterizing the information to be included in the event calendar;
evaluating, by a fact module comprising at least a portion of a a situation analysis module, data corresponding to an event documented in the event calendar to determine who, by at least one of type, number, and another parameter associated with and characterizing people as attendees, is at the event selected from the event calendar;
determining, by the situation analysis module, two facts selected from where persons will be, near an event venue, why, an explicit description of a state of mind thereof, and an implicit description of the state of mind thereof;
obtaining from the database, by the fact module and event engine facts characterizing a situation specifically corresponding to the attendees, venue, and time corresponding to the event.

20. An article, programmed as a demographic predictor system communicating over social media platforms demographic prediction of a population of attendees at an event, the article comprising a non-transitory, computer readable storage medium storing modules constituting executables executable on a processor and operational data operated on by the processor, the modules comprising:
a partner module accessing a host module creating and hosting a database corresponding to an event calendar by selecting and processing data characterizing persistent data corresponding to a venue, and transitory data characterizing time, performers, and attendees corresponding to an event reflected in the event calendar,
a server module serving the event calendar,
a market maker module determining a combination of the persistent data and transitory data characterizing the information included in the event calendar,
a situation analysis module having a fact module that evaluates and determines who, by at least one of type, number, and another parameter associated with and characterizing people as attendees, is at the event selected from the event calendar,
the situation analysis module, further programmed to determine at least two facts selected from where persons will be, near an event venue, why, an explicit description of state of mind thereof, and an implicit state of mind thereof; and
the situation module, further programmed to process information, obtained from the database and event engine, to assess key facts of a situation corresponding to the persons, the event venue, and the time selected.
